(19) United States
(12) Patent Application Publication
(10) Pub. No.: US 2021/0400950 A1
(43) Pub. Date: Dec. 30, 2021

(54) RODENT TRAP BAIT CAGE, SYSTEM AND METHOD

(71) Applicant: Roman Spandrio, Camarillo, CA (US)

(72) Inventor: Roman Spandrio, Camarillo, CA (US)

(21) Appl. No.: 17/356,535

(22) Filed: Jun. 24, 2021

Related U.S. Application Data
(60) Provisional application No. 63/044,169, filed on Jun. 25, 2020.

(51) Int. Cl. A01M 23/24; A01M 23/30

(52) U.S. Cl. CPC A01M 23/245; A01M 23/30

(57) ABSTRACT

Embodiments of a rodent trap bait cage, and associated systems and methods, are disclosed. The bait cage may comprise a barrier portion and a mounting portion. The barrier portion may define a bait cavity therein and include a multiplicity of bait access apertures extending between the bait cavity and an ambient environment. The bait cage may be mountable to a treadle plate of a rodent trap by way of the mounting portion. The mounting portion may include a bait pin detent portion. The barrier portion may include a roof disposed oppositely of the mounting portion. A bait pin aperture may be defined between the roof and the bait pin detent portion and configured to receive a bait pin of the treadle plate to secure the mounting. The bait pin detent portion may have a ramped surface to facilitate wedging of the bait pin detent portion under the bait pin.

### RELATED APPLICATIONS

This application claims the benefit of U.S. Provisional Application No. 63/044,169 filed Jun. 25, 2020, the content of which is incorporated by this reference in its entirety for all purposes as if fully set forth herein.

### TECHNICAL FIELD

The disclosure herein relates generally to rodent traps. More particularly, the present disclosure relates to rodent traps with mechanisms for hindering removal of bait from the trap by a rodent.

### BACKGROUND

Rodent infestations in areas occupied by people can lead to disease and compromised living conditions. Undesired rodent populations have historically and continue to be a major global health problem. Quick-kill rodent traps are the most effective at controlling rodent populations while presenting the least environmental impact. Conventional quick-kill rodent traps, including snap-type traps, generally have physical placeholders for bait connected to some sort of trigger mechanism. The placeholders for bait are not always effective in encouraging a triggering of the trap such that the rodents are successfully killed. The prevailing complaints of quick-kill trap users include traps that have not triggered and the bait is gone, or traps that have triggered and the bait is gone. Rodents, especially rats and mice, are notoriously clever at taking food without disrupting surroundings. This makes typical conventional quick-kill, or snap-type traps, questionable in their effectiveness for killing and ultimately controlling an undesired rodent population.

### SUMMARY

One or more deficiencies of the prior art are solved by way of embodiments of the rodent trap bait cage, system and method in accordance with the present disclosure.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a perspective view of a prior art rodent trap having a narrow treadle plate with bait pin;

FIG. 2 is a perspective view of a prior art rodent trap having a wide treadle plate with bait pin;

FIG. 3 is a perspective view of a first example rodent trap bait cage in accordance with the present disclosure;

FIG. 4 is a further perspective view of the example rodent trap bait cage of FIG. 1;

FIG. 5 is a further perspective view of the example rodent trap bait cage of FIG. 1;

FIG. 6 is a further perspective view of the example rodent trap bait cage of FIG. 1;

FIG. 7 is a rear view of the example rodent trap bait cage of FIG. 1;

FIG. 8 is a side view of the example rodent trap bait cage of FIG. 1;

FIG. 9 is a front view of the example rodent trap bait cage of FIG. 1;

FIG. 10 is a top view of the example rodent trap bait cage of FIG. 1;

FIG. 11 is a bottom view of the example rodent trap bait cage of FIG. 1;

FIG. 12 is a cross-sectional view taken along lines 12-12 in FIG. 9;

FIG. 13 is a perspective view of a rodent trap system incorporating the example rodent trap bait cage of FIG. 1, wherein the rodent trap bait cage is shown in the process of being mounted to the treadle plate of the rodent trap;

FIG. 14 is a perspective view of the rodent trap system of FIG. 13, but wherein the rodent trap bait cage is shown mounted to the treadle plate of the rodent trap;

FIG. 15 is a partial cross-sectional view taken along lines 15-15 in FIG. 14;

FIG. 16 is a cross-sectional view taken along lines 16-16 in FIG. 14;

FIG. 17 is a perspective view of a second example rodent trap bait cage in accordance with the present disclosure;

FIG. 18 is a further perspective view of the example rodent trap bait cage of FIG. 17;

FIG. 19 is a further perspective view of the example rodent trap bait cage of FIG. 17;

FIG. 20 is a further perspective view of the example rodent trap bait cage of FIG. 17;

FIG. 21 is a rear view of the example rodent trap bait cage of FIG. 17;

FIG. 22 is a side view of the example rodent trap bait cage of FIG. 17;

FIG. 23 is a front view of the example rodent trap bait cage of FIG. 17;

FIG. 24 is a top view of the example rodent trap bait cage of FIG. 17;

FIG. 25 is a bottom view of the example rodent trap bait cage of FIG. 17;

FIG. 26 is a cross-sectional view taken along lines 26-26 in FIG. 23;

FIG. 27 is a perspective view of a rodent trap system incorporating the example rodent trap bait cage of FIG. 17, wherein the rodent trap bait cage is shown mounted to the treadle plate of the rodent trap;

FIG. 28 is a partial cross-sectional view taken along lines 28-28 in FIG. 27;

FIG. 28A is a partial cross-sectional view of a rodent trap system similar to that of FIG. 28, but wherein the rodent trap bait cage is shown mounted to the treadle plate of the rodent trap in a reverse orientation opposite to that shown in FIG. 28;

FIG. 29 is a perspective view of an alternate rodent trap system incorporating the example rodent trap bait cage of FIG. 17, wherein the rodent trap bait cage is shown mounted to a different type of treadle plate from that shown in FIG. 27;

FIG. 30 is a partial cross-sectional view taken along lines 30-30 in FIG. 29;

FIG. 31 is a perspective view of a rodent trap system similar to that of FIG. 29, but wherein the rodent trap bait cage is shown mounted to the treadle plate of the rodent trap in a reverse orientation opposite to that shown in FIG. 29;

FIG. 32 is a partial cross-sectional view taken along lines 32-32 in FIG. 31;

FIG. 33 is a perspective view of a third example rodent trap bait cage in accordance with the present disclosure;

FIG. 34 is a further perspective view of the example rodent trap bait cage of FIG. 33;

FIG. 35 is a further perspective view of the example rodent trap bait cage of FIG. 33;

FIG. 36 is a further perspective view of the example rodent trap bait cage of FIG. 33;

FIG. 37 is a rear view of the example rodent trap bait cage of FIG. 33;

FIG. 38 is a side view of the example rodent trap bait cage of FIG. 33;

FIG. 39 is a front view of the example rodent trap bait cage of FIG. 33;

FIG. 40 is a top view of the example rodent trap bait cage of FIG. 33;

FIG. 41 is a bottom view of the example rodent trap bait cage of FIG. 33;

FIG. 42 is a cross-sectional view taken along lines 42-42 in FIG. 39;

FIG. 43 is a perspective view of a rodent trap system incorporating the example rodent trap bait cage of FIG. 33, wherein the rodent trap bait cage is shown mounted to the treadle plate of the rodent trap;

FIG. 44 is a partial cross-sectional view taken along lines 44-44 in FIG. 43;

FIG. 45 is a partial cross-sectional view of a rodent trap system similar to that of FIG. 44, but wherein the rodent trap bait cage is shown mounted to the treadle plate of the rodent trap in a reverse orientation opposite to that shown in FIG. 44;

FIG. 46 is a perspective view of a fourth example rodent trap bait cage in accordance with the present disclosure;

FIG. 47 is a further perspective view of the example rodent trap bait cage of FIG. 46;

FIG. 48 is a further perspective view of the example rodent trap bait cage of FIG. 46;

FIG. 49 is a further perspective view of the example rodent trap bait cage of FIG. 46;

FIG. 50 is a rear view of the example rodent trap bait cage of FIG. 46;

FIG. 51 is a side view of the example rodent trap bait cage of FIG. 46;

FIG. 52 is a front view of the example rodent trap bait cage of FIG. 46;

FIG. 53 is a top view of the example rodent trap bait cage of FIG. 46;

FIG. 54 is a bottom view of the example rodent trap bait cage of FIG. 46;

FIG. 55 is a cross-sectional view taken along lines 55-55 in FIG. 52;

FIG. 56 is a perspective view of a rodent trap system incorporating the example rodent trap bait cage of FIG. 46, wherein the rodent trap bait cage is shown in the process of being mounted to the treadle plate of the rodent trap;

FIG. 57 is a perspective view of the rodent trap system of FIG. 56, but wherein the rodent trap bait cage is shown mounted to the treadle plate of the rodent trap;

FIG. 58 is a partial cross-sectional view taken along lines 58-58 in FIG. 57;

FIG. 59 is a cross-sectional view taken along lines 59-59 in FIG. 57;

FIG. 60 is a perspective view of a fifth example rodent trap bait cage in accordance with the present disclosure;

FIG. 61 is a further perspective view of the example rodent trap bait cage of FIG. 60;

FIG. 62 is a further perspective view of the example rodent trap bait cage of FIG. 60;

FIG. 63 is a further perspective view of the example rodent trap bait cage of FIG. 60;

FIG. 64 is a rear view of the example rodent trap bait cage of FIG. 60;

FIG. 65 is a side view of the example rodent trap bait cage of FIG. 60;

FIG. 66 is a front view of the example rodent trap bait cage of FIG. 60;

FIG. 67 is a top view of the example rodent trap bait cage of FIG. 60;

FIG. 68 is a bottom view of the example rodent trap bait cage of FIG. 60;

FIG. 69 is a cross-sectional view taken along lines 69-69 in FIG. 66;

FIG. 70 is a perspective view of a rodent trap system incorporating the example rodent trap bait cage of FIG. 60, wherein the rodent trap bait cage is shown in the process of being mounted to the treadle plate of the rodent trap;

FIG. 71 is a perspective view of the rodent trap system of FIG. 70, but wherein the rodent trap bait cage is shown mounted to the treadle plate of the rodent trap;

FIG. 72 is a partial cross-sectional view taken along lines 72-72 in FIG. 71;

FIG. 73 is a cross-sectional view taken along lines 73-73 in FIG. 71;

FIG. 74 is a perspective view of a sixth example rodent trap bait cage in accordance with the present disclosure, wherein the mounting portion includes a mounting door shown in an open position;

FIG. 75 is a further perspective view of the example rodent trap bait cage of FIG. 74;

FIG. 76 is a further perspective view of the example rodent trap bait cage of FIG. 74;

FIG. 77 is a further perspective view of the example rodent trap bait cage of FIG. 74;

FIG. 78 is a side view of the example rodent trap bait cage of FIG. 74;

FIG. 79 is an opposing side view of the example rodent trap bait cage of FIG. 74;

FIG. 80 is a rear view of the example rodent trap bait cage of FIG. 74;

FIG. 81 is a front view of the example rodent trap bait cage of FIG. 74;

FIG. 82 is a top view of the example rodent trap bait cage of FIG. 74;

FIG. 83 is a bottom view of the example rodent trap bait cage of FIG. 74;

FIG. 84 is a perspective view of the sixth example rodent trap bait cage of FIG. 74, but wherein the mounting door is shown in a closed position;

FIG. 85 is a further perspective view of the example rodent trap bait cage of FIG. 84;

FIG. 86 is a further perspective view of the example rodent trap bait cage of FIG. 84;

FIG. 87 is a further perspective view of the example rodent trap bait cage of FIG. 84;

FIG. 88 is a side view of the example rodent trap bait cage of FIG. 84;

FIG. 89 is an opposing side view of the example rodent trap bait cage of FIG. 84;

FIG. 90 is a front view of the example rodent trap bait cage of FIG. 84;

FIG. 91 is a rear view of the example rodent trap bait cage of FIG. 84;

FIG. 92 is a top view of the example rodent trap bait cage of FIG. 84;

FIG. 93 is a bottom view of the example rodent trap bait cage of FIG. 84;

FIG. 94 is a cross-sectional view taken along lines 94-94 in FIG. 90;

FIG. 95 is a perspective view of a rodent trap system incorporating the example rodent trap bait cage of FIG. 74, wherein the rodent trap bait cage is shown with its mounting door in an open position and in the process of being mounted to the treadle plate of the rodent trap;

FIG. 96 is a perspective view of a rodent trap system of FIG. 95, but wherein the rodent trap bait cage is shown in a mounting position on the treadle plate with its mounting door in still an open position;

FIG. 97 is a perspective view of the rodent trap system of FIG. 96, but wherein the rodent trap bait cage is shown mounted to the treadle plate of the rodent trap with the mounting door retained in a closed position;

FIG. 98 is a cross-sectional view taken along lines 98-98 in FIG. 97

FIG. 99 is a perspective view of a seventh example rodent trap bait cage in accordance with the present disclosure;

FIG. 100 is a further perspective view of the example rodent trap bait cage of FIG. 99;

FIG. 101 is a further perspective view of the example rodent trap bait cage of FIG. 99;

FIG. 102 is a further perspective view of the example rodent trap bait cage of FIG. 99;

FIG. 103 is a rear view of the example rodent trap bait cage of FIG. 99;

FIG. 104 is a side view of the example rodent trap bait cage of FIG. 99;

FIG. 105 is a front view of the example rodent trap bait cage of FIG. 99;

FIG. 106 is a top view of the example rodent trap bait cage of FIG. 99;

FIG. 107 is a bottom view of the example rodent trap bait cage of FIG. 99;

FIG. 108 is a cross-sectional view taken along lines 108-108 in FIG. 99;

FIG. 109 is a perspective view of a rodent trap system incorporating the example rodent trap bait cage of FIG. 99, wherein the rodent trap bait cage is shown with a peel layer being peeled away to expose an adhesive layer in the process of the bait cage being mounted to the treadle plate of the rodent trap;

FIG. 110 is a perspective view of the rodent trap system of FIG. 109, but wherein the rodent trap bait cage is shown mounted to the treadle plate of the rodent trap by way of the adhesive layer;

FIG. 111 is a magnified partial side view of the rodent trap system shown in FIG. 110;

FIG. 112 is a perspective view of a prior art rodent trap having a bait holder mounted in the base portion rather than on the treadle plate;

FIG. 113 is a perspective view of an eighth example rodent trap bait cage in accordance with the present disclosure;

FIG. 114 is a further perspective view of the example rodent trap bait cage of FIG. 113;

FIG. 115 is top view of the example rodent trap bait cage of FIG. 113;

FIG. 116 is a bottom view of the example rodent trap bait cage of FIG. 113;

FIG. 117 is a front view of the example rodent trap bait cage of FIG. 113;

FIG. 118 is a side view of the example rodent trap bait cage of FIG. 113;

FIG. 119 is a cross-sectional view taken along lines 119-119 in FIG. 117;

FIG. 120 is a cross-sectional view taken along lines 120-120 in FIG. 117;

FIG. 121 is a perspective view of a rodent trap system incorporating the example rodent trap bait cage of FIG. 113, wherein the rodent trap bait cage is shown in the process of being mounted to a bait holder of the corresponding rodent trap;

FIG. 122 is a perspective view similar to that of FIG. 121, but wherein the rodent trap bait cage is shown mounted to the bait holder of the corresponding rodent trap;

FIG. 123 is a perspective view similar to that of FIG. 122, but wherein the bait cage is mounted to the corresponding rodent trap by way of the bait holder;

FIG. 124 is a cross-sectional view taken along lines 124-124 in FIG. 123;

FIG. 125 is a perspective view of a ninth example rodent trap bait cage in accordance with the present disclosure, wherein the bait cage is symmetrical about the plane defined by the vertical axis and the lateral axis, and the plane defined by the vertical axis and the longitudinal axis;

FIG. 126 is a further perspective view of the example rodent trap bait cage of FIG. 125;

FIG. 127 is a front view of the example rodent trap bait cage of FIG. 125;

FIG. 128 is a side view of the example rodent trap bait cage of FIG. 125;

FIG. 129 is a rear view of the example rodent trap bait cage of FIG. 125;

FIG. 130 is top view of the example rodent trap bait cage of FIG. 125;

FIG. 131 is a bottom view of the example rodent trap bait cage of FIG. 125;

FIG. 132 is a cross-sectional view taken along lines 132-132 in FIG. 127;

FIG. 133 is a partial perspective view of a treadle plate of a rodent trap, wherein the treadle plate includes a bait pin;

FIG. 134 is a partial perspective view similar to that of FIG. 133, but wherein an example bait cage similar to that of FIG. 17 is placed in a precursor position on the treadle plate;

FIG. 135 is a partial perspective view similar to that of FIG. 134, but wherein a user is shown applying a downward force on the roof portion of the bait cage, thereby imparting a torsion to the bait pin detent portion so as to cause a reduction in the ramp angle;

FIG. 136 is a partial perspective view similar to that of FIG. 135, but wherein a user is shown simultaneously applying the downward force and a forward force on the roof portion of the bait cage, thereby causing the bait cage to slide into a mounting position on the treadle plate with the bait pin being received by the bait pin aperture of the bait cage;

FIG. 137 is a partial perspective view similar to that of FIG. 136, but wherein the user has released all forces previously imposed on the roof portion of the bait cage, thereby allowing the ramp angle to return toward its normal position so that the bait pin detent portion is wedged between the bait pin and the treadle plate to securely mount the bait cage to the treadle plate;

FIG. 138 is a partial perspective view of a treadle plate of an alternate rodent trap, wherein the treadle plate is wide and includes a bait pin;

FIG. 139 is a partial perspective view similar to that of FIG. 138, but wherein an example bait cage similar to that of FIG. 17 is placed in a precursor position on the treadle plate;

FIG. 140 is a partial perspective view similar to that of FIG. 140, but wherein a user is shown applying a downward force on the roof portion of the bait cage, thereby imparting a torsion to the bait pin detent portion so as to cause a reduction in the ramp angle;

FIG. 141 is a partial perspective view similar to that of FIG. 140, but wherein a user is shown simultaneously applying the downward force and a forward force on the roof portion of the bait cage, thereby causing the bait cage to slide into a mounting position on the treadle plate with the bait pin being received by the bait pin aperture of the bait cage;

FIG. 142 is a partial perspective view similar to that of FIG. 141, but wherein the user has released all forces previously imposed on the roof portion of the bait cage, thereby allowing the ramp angle to return toward its normal position so that the bait pin detent portion is wedged between the bait pin and the treadle plate to securely mount the bait cage to the treadle plate;

FIG. 143 is a diagrammatic partial cross-sectional view of the bait cage and treadle plate of FIG. 135, illustrating the elastic deformation of the bait cage when a user applies a downward force to the roof portion, and the resulting reduction in the ramp angle;

FIG. 144 is a diagrammatic partial cross-sectional view of the bait cage and treadle plate of FIG. 136, illustrating the elastic deformation of the bait cage when a user applies a downward force to the roof portion, and the ability of the user to slide the bait cage into mounting position on the treadle plate due to the reduced ramp angle providing clearance for receipt of the bait pin by the bait pin aperture.

FIG. 145 is a perspective view of a tenth example rodent trap bait cage in accordance with the present disclosure;

FIG. 146 is a further perspective view of the example rodent trap bait cage of FIG. 145;

FIG. 147 is a further perspective view of the example rodent trap bait cage of FIG. 145;

FIG. 148 is a further perspective view of the example rodent trap bait cage of FIG. 145;

FIG. 149 is a rear view of the example rodent trap bait cage of FIG. 145;

FIG. 150 is a side view of the example rodent trap bait cage of FIG. 145;

FIG. 151 is a front view of the example rodent trap bait cage of FIG. 145;

FIG. 152 is a top view of the example rodent trap bait cage of FIG. 145;

FIG. 153 is a bottom view of the example rodent trap bait cage of FIG. 145;

FIG. 154 is a cross-sectional view taken along lines 154-154 in FIG. 151;

FIG. 155 is a perspective view of a rodent trap system incorporating the example rodent trap bait cage of FIG. 145, wherein the rodent trap bait cage is shown in the process of being mounted to the treadle plate of the rodent trap;

FIG. 156 is a perspective view of the rodent trap system of FIG. 155, but wherein the rodent trap bait cage is shown mounted to the treadle plate of the rodent trap;

FIG. 157 is a partial cross-sectional view similar to that shown in FIG. 158, but wherein the rodent trap bait cage is shown in a precursor partially-mounted configuration in which the bait pin detent portion is being inserted under the bait pin while tilted upward;

FIG. 158 is a cross-sectional view taken along lines 158-158 in FIG. 156, illustrated the rodent trap bait cage having been rotated about the bait pin detent portion to being the plate engagement members into retaining engagement with the lateral edges of the treadle plate; and

FIG. 159 is a block diagram of one non-limiting example method of deploying a rodent trap bait cage on a rodent trap.

### DETAILED DESCRIPTION OF THE PREFERRED EMBODIMENTS

Referring now to the drawings, like reference numerals designate identical or corresponding features throughout the several views.

With reference to the several drawings, various example embodiments of a rodent trap bait cage in accordance with the present disclosure are shown generally at 100, and preferably comprise a barrier portion 102 and a mounting portion 104. The barrier portion 102 defines a bait cavity 106 therein and preferably includes a multiplicity of bait access apertures (108 and 168) extending between the bait cavity 106 and an ambient environment 110 surrounding the barrier portion 102. The bait cage 100 may preferably be configured to be mounted to a treadle plate 404 of a rodent trap 400 by way of the mounting portion 104. The bait access apertures may be configured to allow a user to insert soft forms of bait 176 through the apertures and into the bait cavity 106 even after the bait cage 100 is mounted to the treadle plate 404.

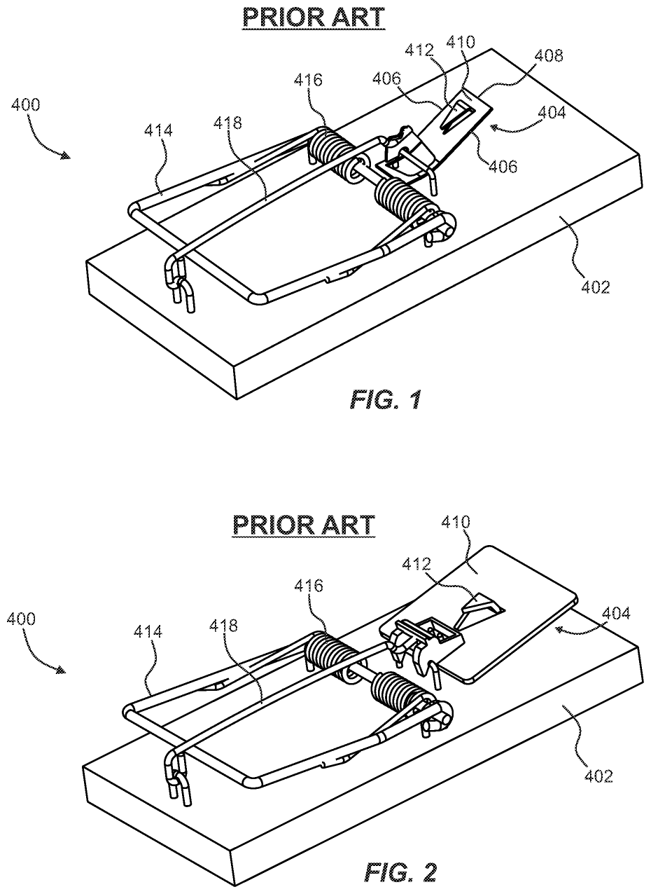

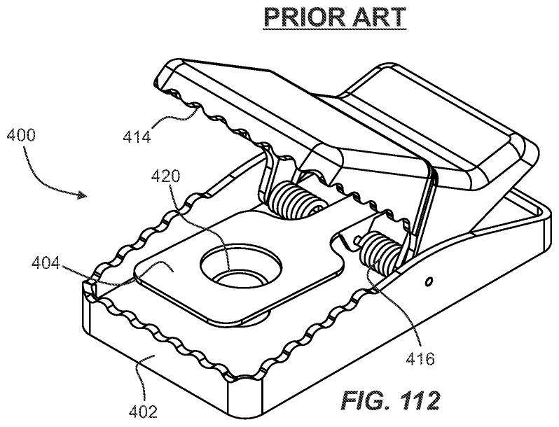

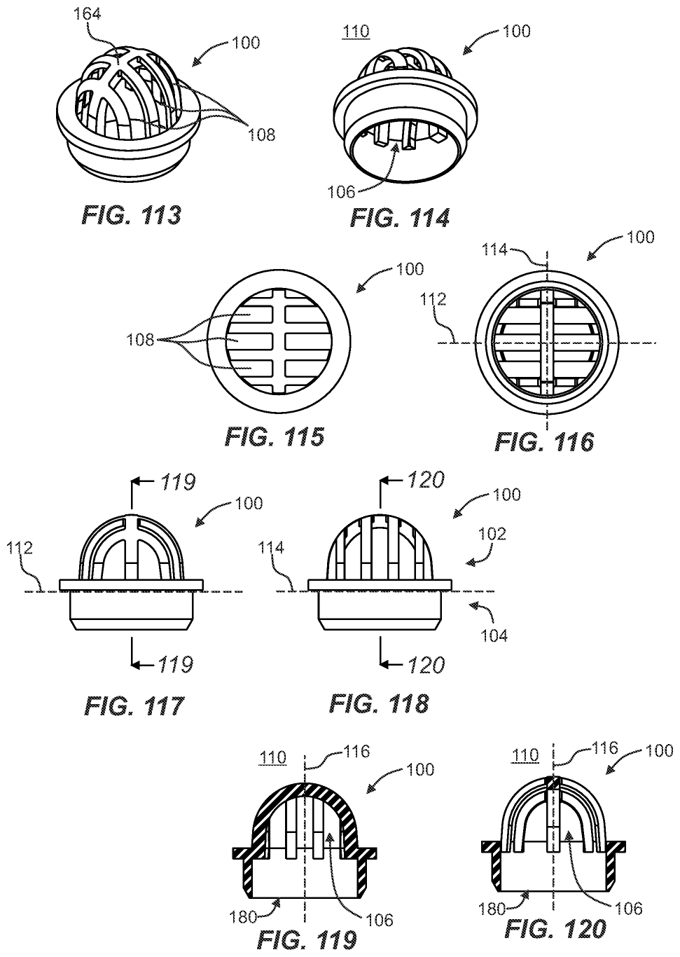

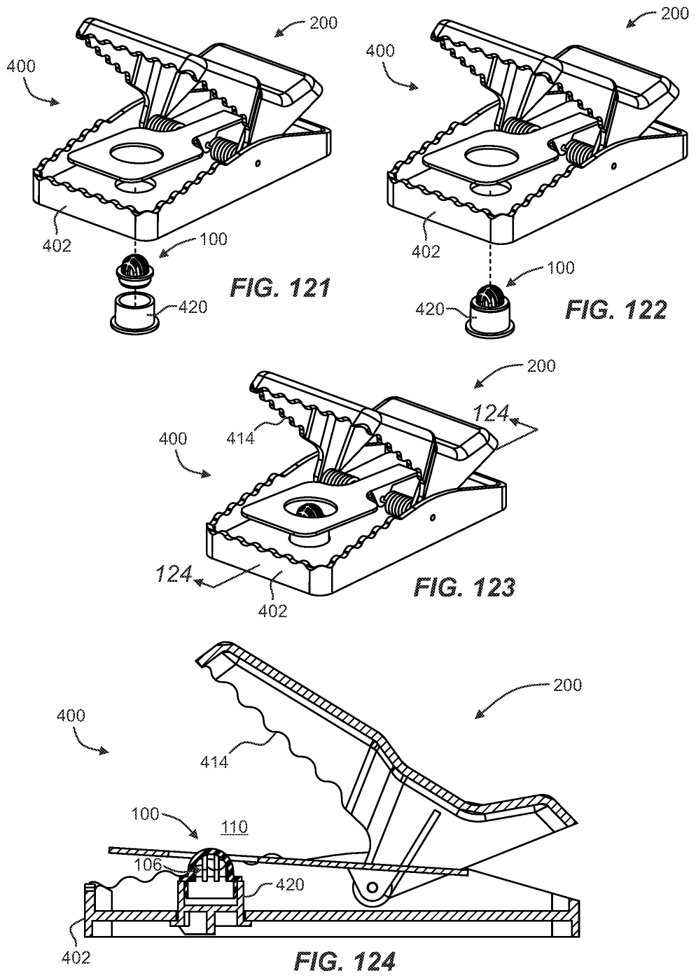

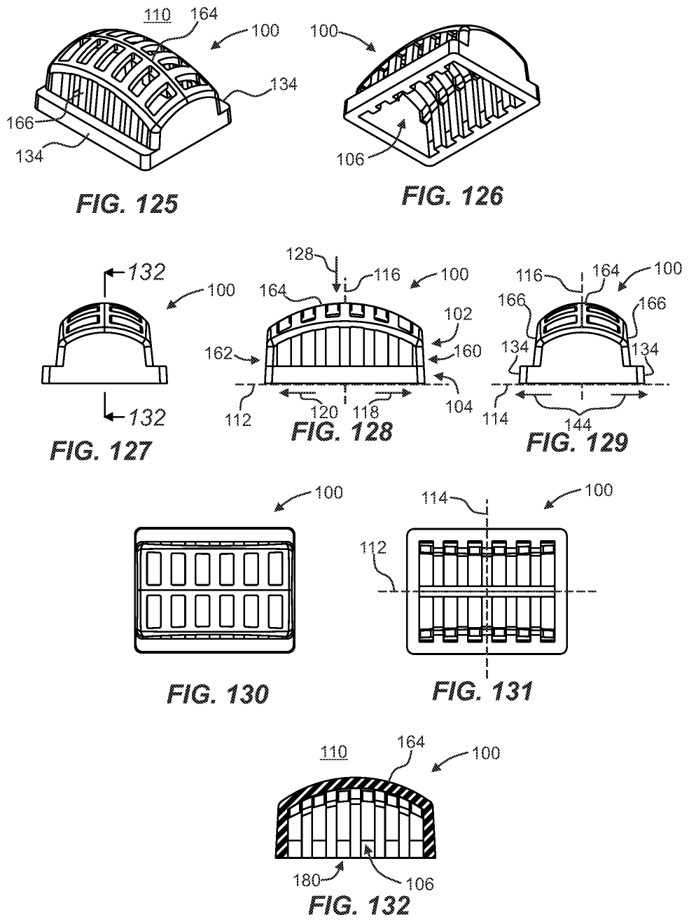

Most of the example embodiments of the bait cage 100 disclosed herein are configured to be deployed on rodent traps featuring treadle plates designed to retain the bait, such as the conventional rodent traps shown at 400 in FIGS. 1 and 2. Such rodent traps 400 may include a base plate 402, a treadle plate 404, a pair of lateral edges 406, a terminal edge 408, an upper face 410, a bait pin 412, a movable jaw 414, a helical spring 416 and a retaining lever 418. At least one of the example embodiments of the rodent trap bait cage 100 disclosed herein, such as the bait cage 100 shown in FIGS. 113 through 124, is configured to be deployed on a rodent trap 400 with a bait holder 420 that is attached to the base plate 402 rather than the treadle plate 404. A conventional version of such a rodent trap is shown at FIG. 112.

As illustrated throughout several of the views, implementations of the rodent trap bait cage 100 may include a longitudinal axis 112, a lateral axis 114 and a vertical axis 116. These axes are disclosed herein in order to provide spatial and directional references for various features, movements and forces associated with the respective bait cage 100.

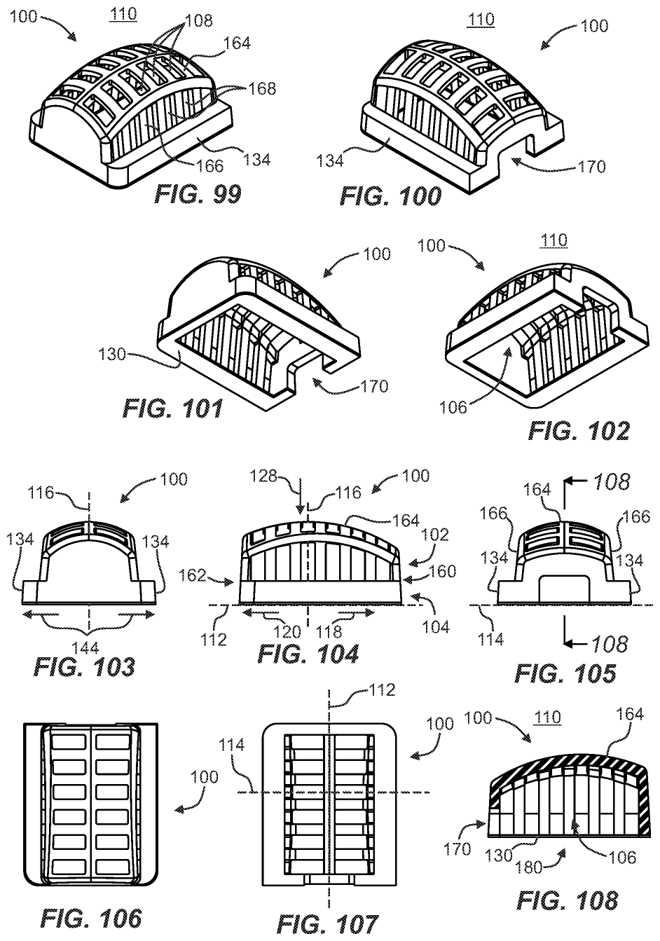

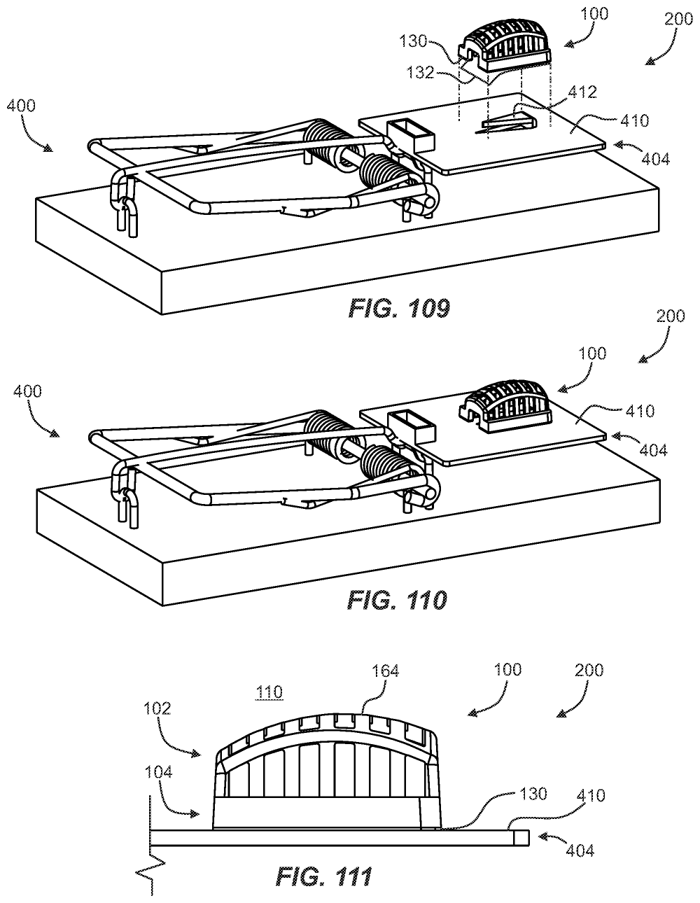

Referring to FIGS. 99-111, certain implementations of a rodent trap bait cage 100 may further comprise an adhesive layer 130 disposed on the mounting portion 104, and a peel layer 132 disposed on the adhesive layer 130 oppositely of the mounting portion 104. As illustrated in FIGS. 109-111, the peel layer 132 is peelable from the adhesive layer 130, and the mounting of such bait cage 100 is configured to be by way of the adhesive layer 130 being in adhering communication between the mounting portion 104 and the treadle plate 404.

In particular implementations of a rodent trap bait cage 100, the mounting portion 104 may include a pair of laterally opposed plate engagement members 134. Each plate engagement member 134 may be configured to retainingly engage a respective lateral edge 406 of the treadle plate 404. In such implementations, the mounting may be by way of the retaining engagement and may be releasable and repeatable.

Referring to FIGS. 7 and 13-16, in particular implementations of a rodent trap bait cage 100, the retaining engagement may be by way of a lateral clamping force 136 exerted by the plate engagement members 134 on the treadle plate 404. The lateral clamping force 136 may be by way of elastic deformation of the rodent trap bait cage 100. For example, when the bait cage 100 is mounted to the treadle plate 404, a tight fit of the treadle plate 404 between the plate engagement members 134 may force the plate engagement members 134 to move elastically in a laterally outward direction 144. This elastic deformation would produce a clamping force 136 in the laterally inward direction, since the plate engagement members 134 are elastically biased to return back to their original positions. Additionally or in the alternative, the retaining engagement may be by way of static friction between the plate engagement members 134 and respective said lateral edges 406 of the treadle plate 404.

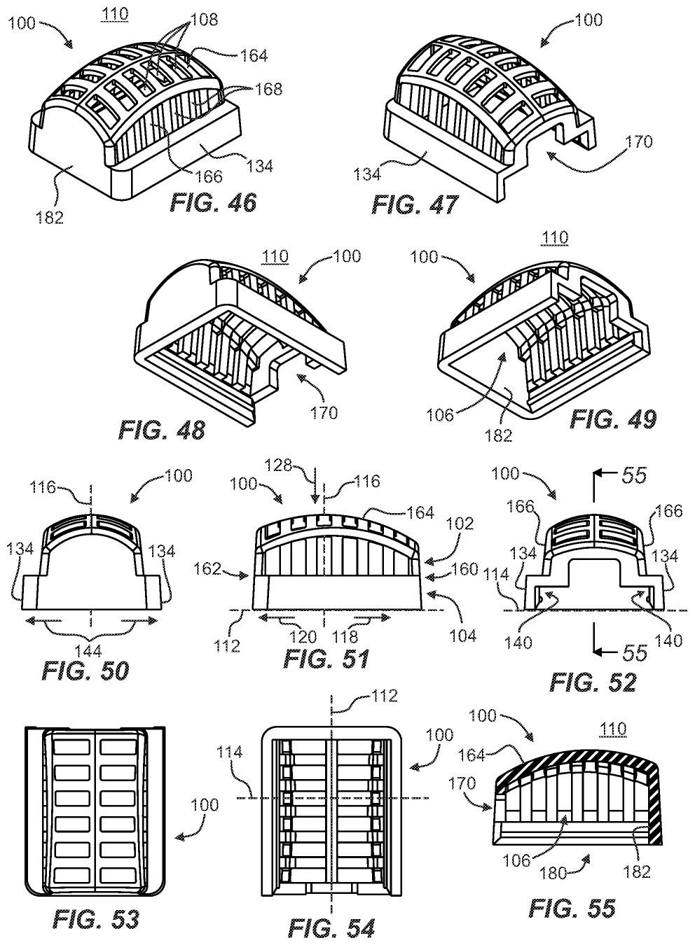

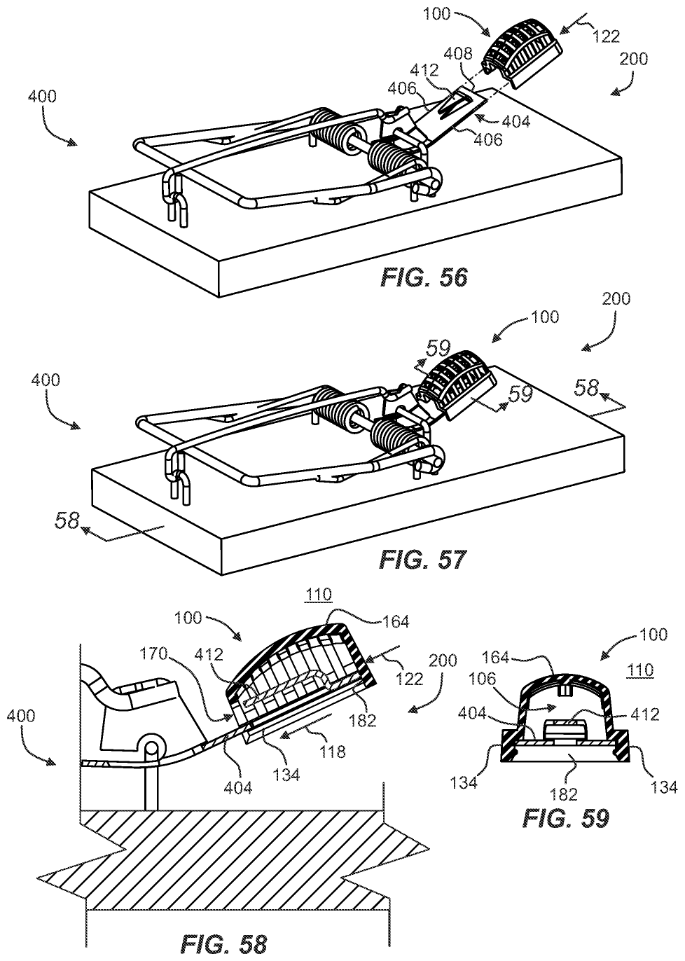

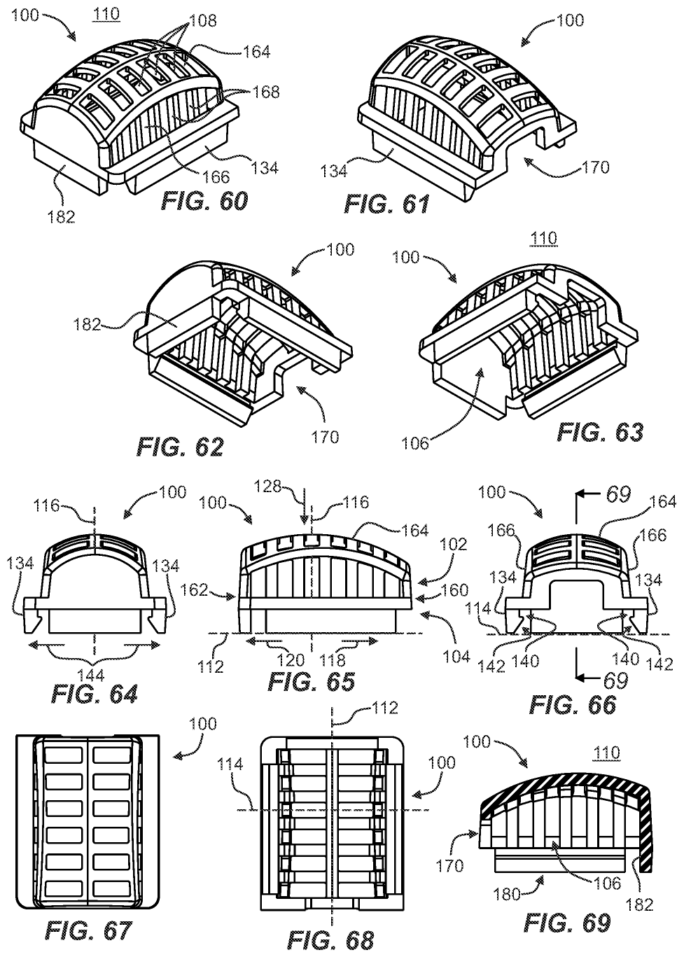

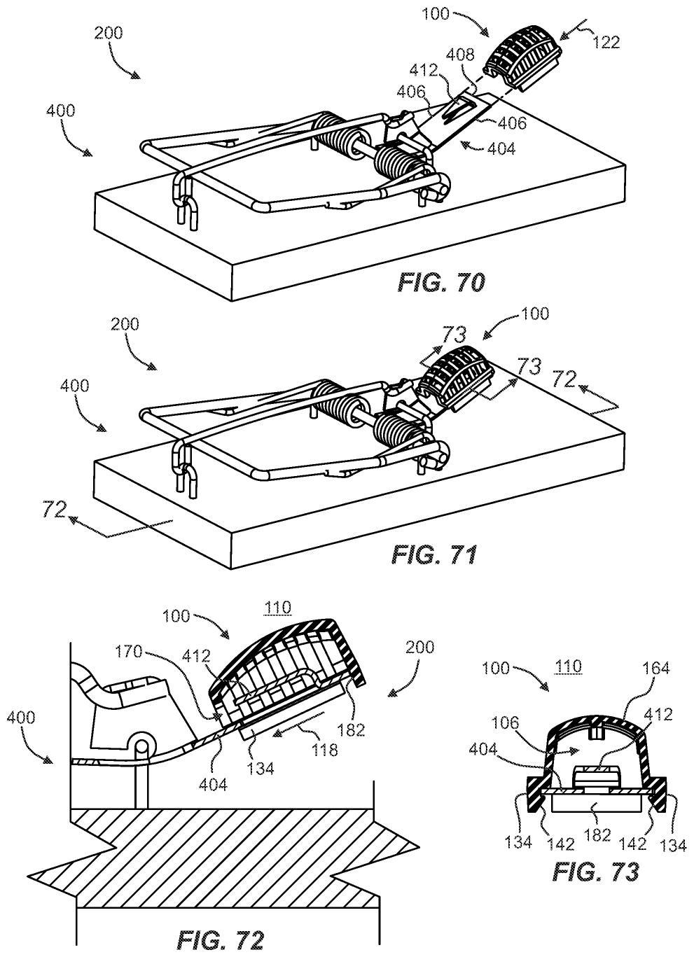

Referring to FIGS. 46-73, in certain implementations of a rodent trap bait cage 100, each of the plate engagement members 134 may include an edge slot 140. In such implementations, the retaining engagement may be by way of receipt of respective said lateral edges 406 of the treadle plate 404 into the edge slots 140. Moreover, as illustrated for example in FIG. 66, each of the plate engagement members 134 may have a lower inboard edge 142 that is tapered. Such a taper may facilitate a vertical snapping engagement of the treadle plate 404 by the mounting portion 104 as distinguished the from the sliding-type engagement illustrated in FIGS. 56 and 70.

Referring to FIGS. 7, 64 and 103, in particular implementations of the rodent trap bait cage 100, each of the plate engagement members 134 may extend laterally outward (e.g., in a laterally outward direction 144) of the barrier portion 102. In other words, the mounting portion 104 may be wider than the barrier portion 102 in the lateral direction.

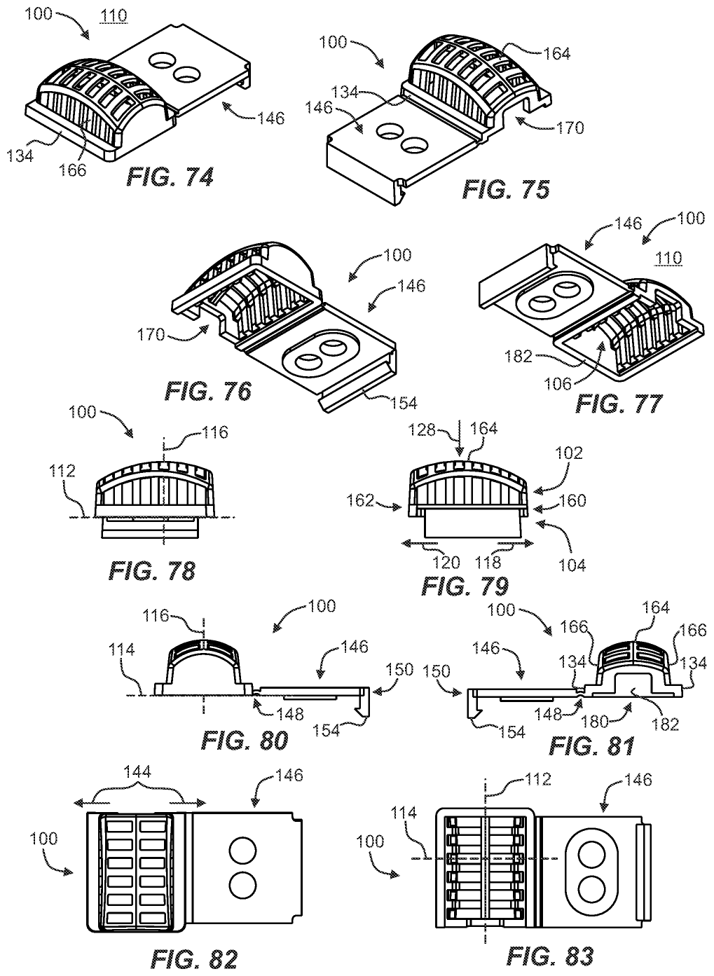

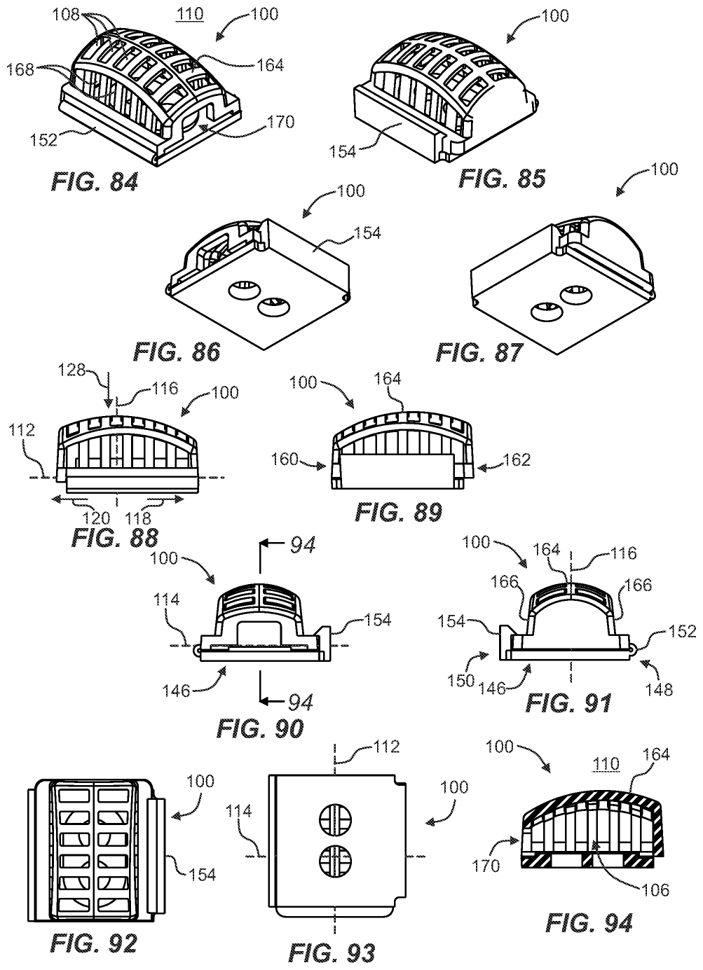

Referring to FIGS. 74-98, in certain implementations of a rodent trap bait cage 100, the mounting portion 104 may include a mounting door 146 and a pair of laterally-opposed plate engagement members 134. The mounting door 146 may have a hinge side 148 and a detent side 150 disposed oppositely of the hinge side 148. The hinge side 148 may be hingedly affixed (for example, by a hinge 152) to one of the plate engagement members 134 for hinged movement of the mounting door 146 between an open position (see, e.g., FIG. 81) and a closed position (see, e.g., FIG. 91). The detent side 150 may be configured to releasably retain the mounting door 146 in the closed position. When the mounting door 146 is releasably retained in the closed position, the mounting door 146 may be configured to retain the treadle plate 404 between the mounting door 146 and the barrier portion 102, thereby securing the mounting of the rodent trap bait cage 100 to the treadle plate 404. Moreover, the detent side 150 may include a cantilever snap member 154 configured to snapingly engage the plate engagement member 134 opposite the plate engagement member 134 to which the hinge side 148 is hingedly affixed. In such implementations, the cantilever snap member 154 may be configured to cause the releasable retention of the mounting door 146 in the closed position.

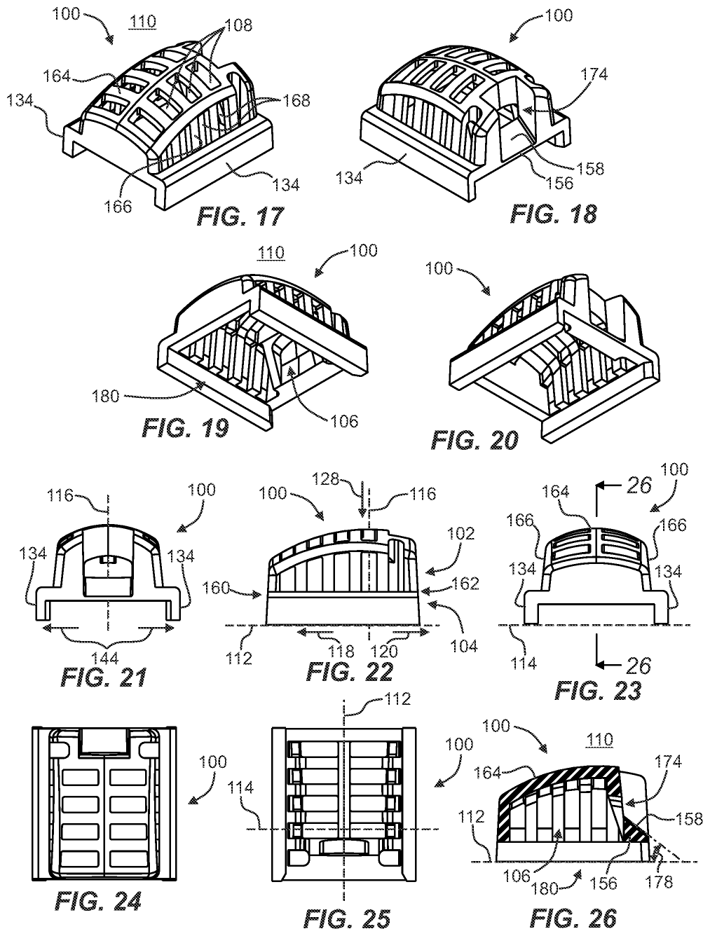

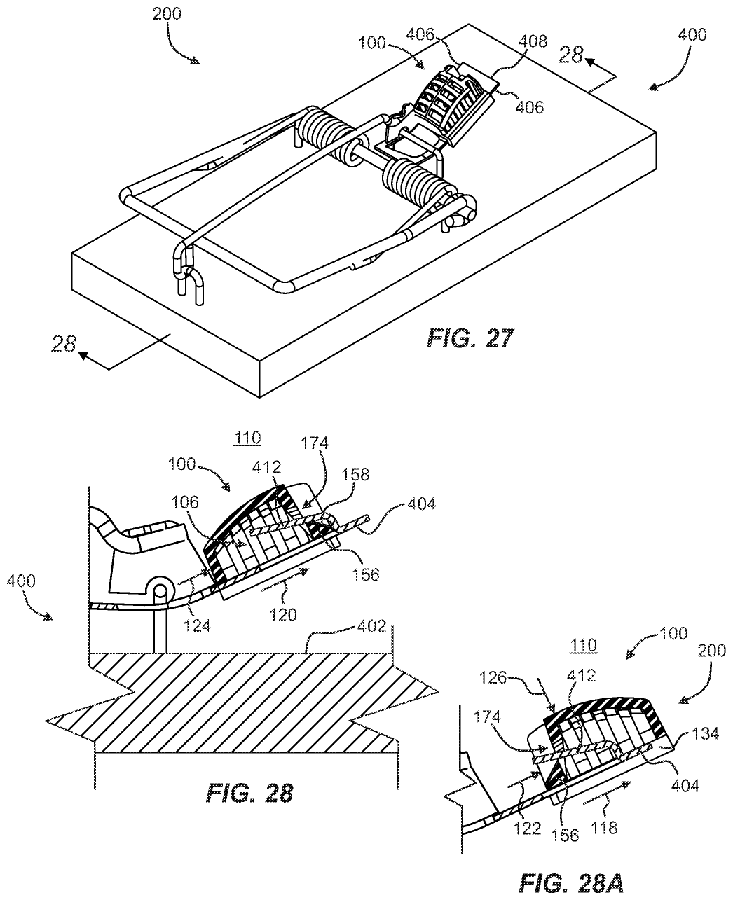

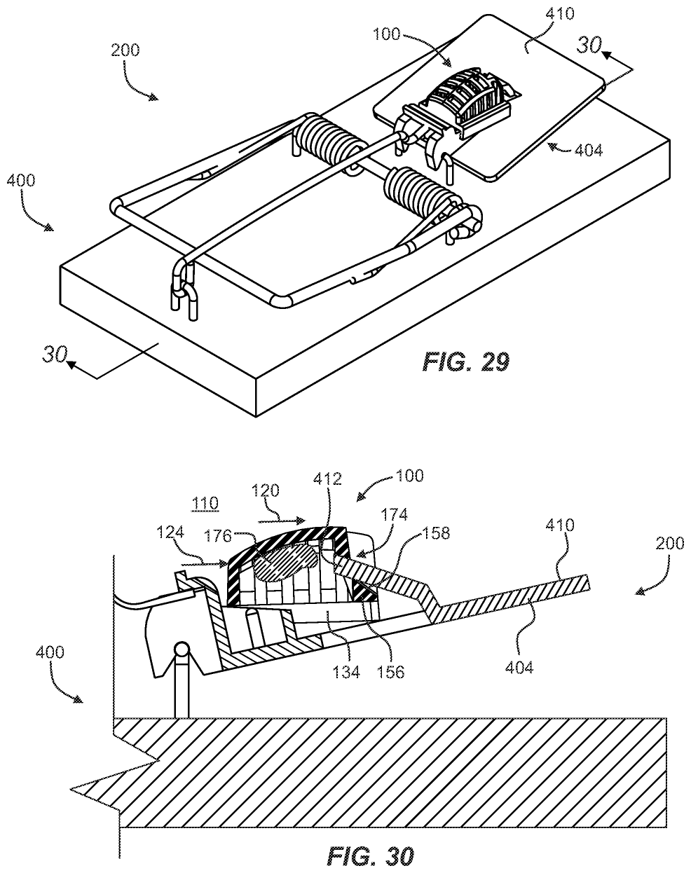

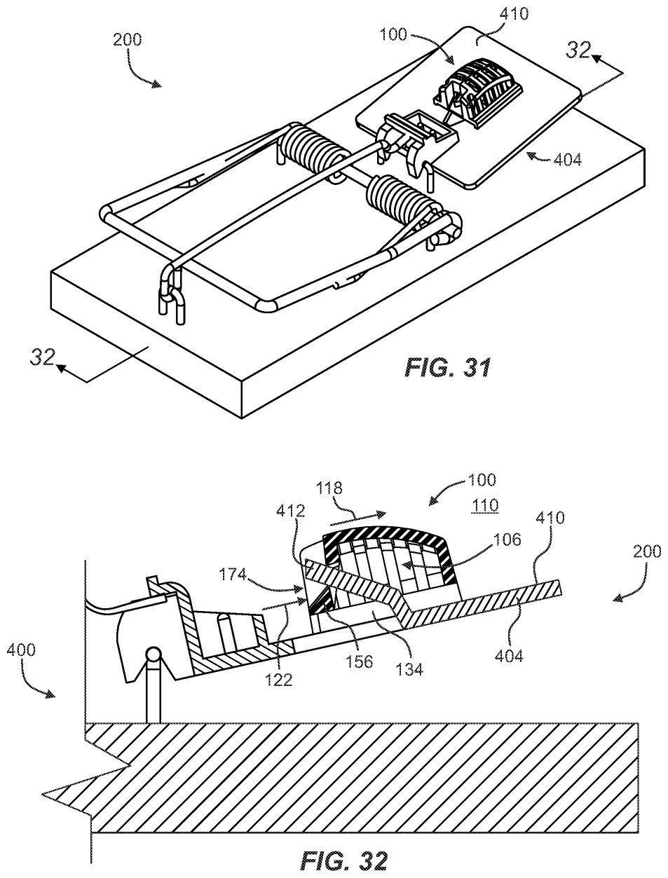

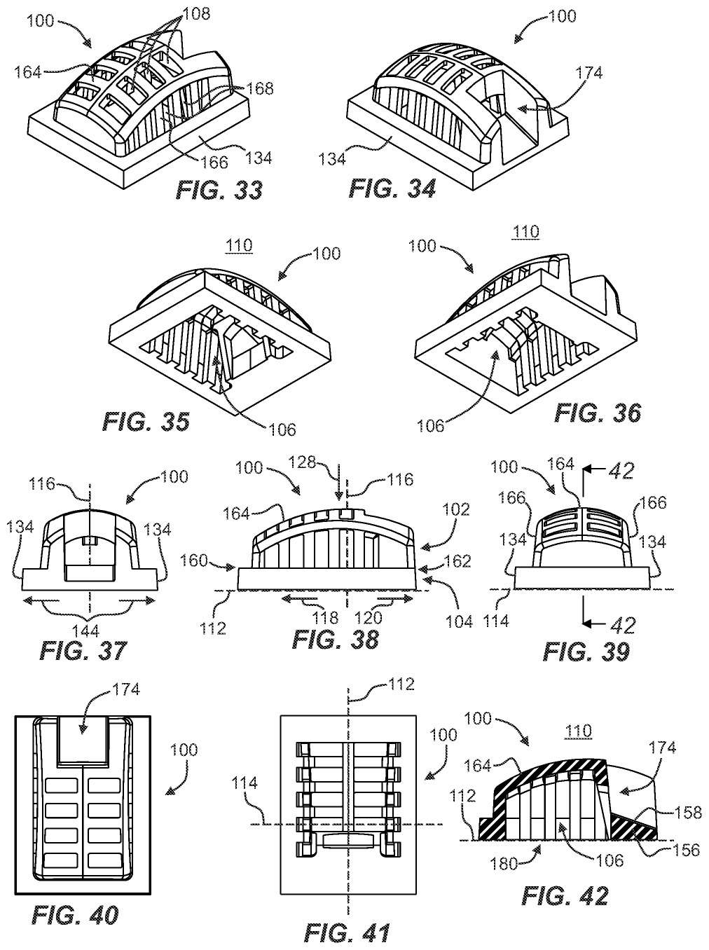

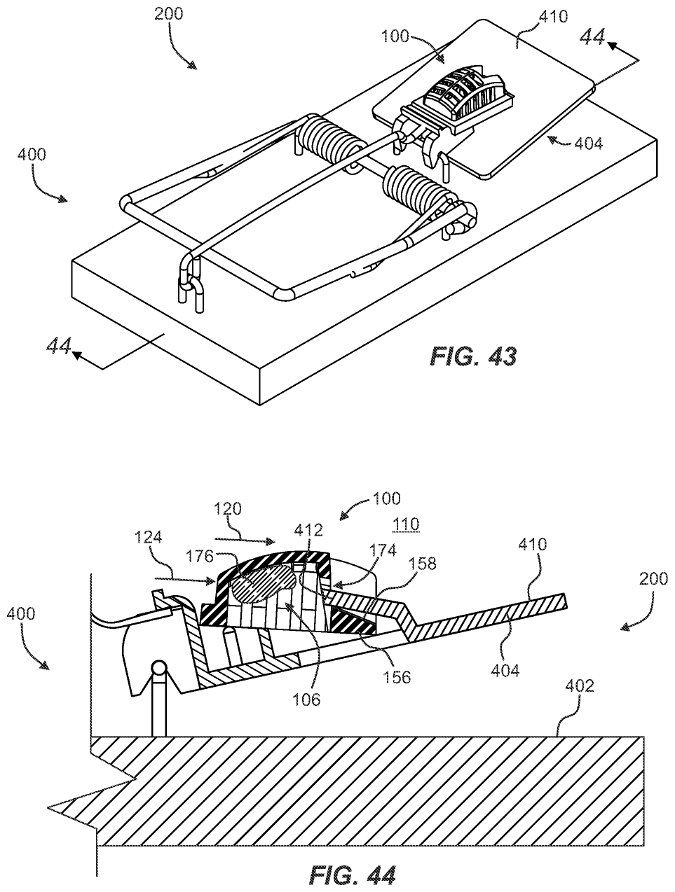

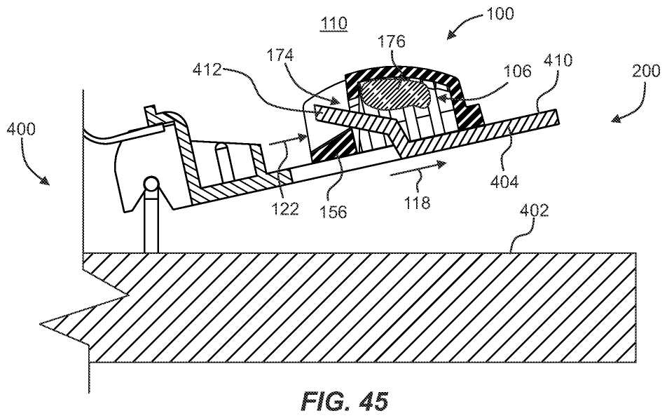

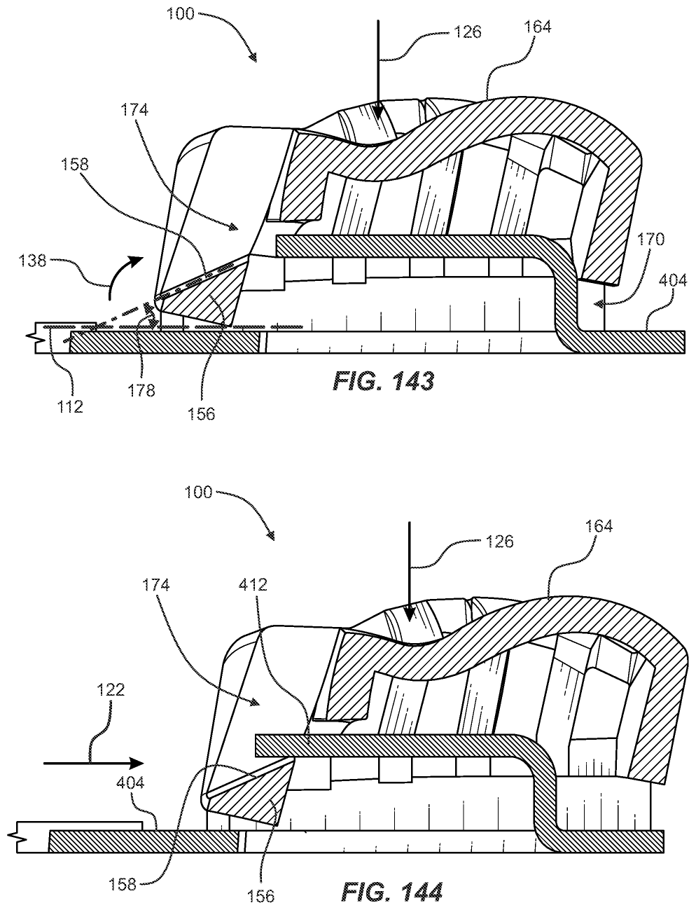

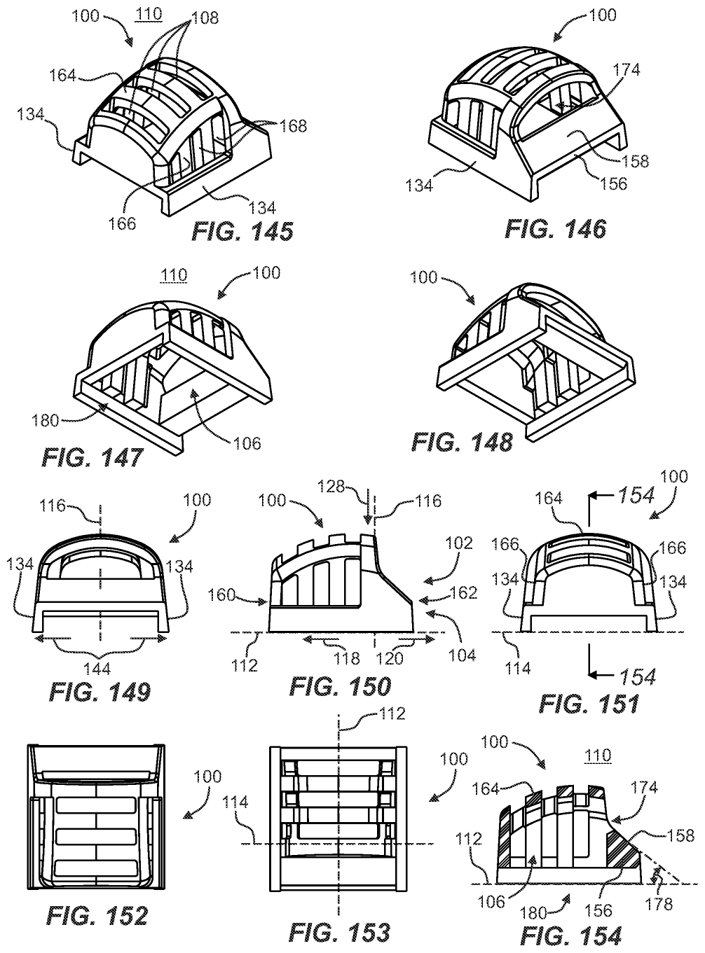

Referring to FIGS. 17-45, in particular implementations of a rodent trap bait cage 100, the mounting portion 104 may include a bait pin detent portion 156. Moreover, the barrier portion 102 may include a roof section 164 disposed oppositely of the mounting portion 104, and a bait pin aperture 174 may be defined between the roof section 164 and the bait pin detent portion 156. The bait cage 100 may include an open bottom portion 180 opposite the roof segment 164. Most or all of the open bottom portion 180 is closed off by the treadle plate 404 once the bait cage 100 is mounted to the treadle plate 404. Referring to FIGS. 28, 28A, 30, 32, 44 and 45, the bait pin aperture 174 may be configured to slidingly receive a bait pin 412 of the treadle plate 404 to secure the mounting of the rodent trap bait cage to the treadle plate 404. The bait pin detent portion 156 may have a ramped surface 158 to facilitate wedging of the bait pin detent portion 156 between the bait pin 412 and the upper face 410 of the treadle plate 404 during said sliding receipt of the bait pin 412 by the bait pin aperture 174. A ramp angle 178 may be defined between the ramped surface 158 and a longitudinal axis 112 of the rodent trap bait cage 100. In particular implementations of the bait cage 100, the ramp angle 178 may preferably be manufactured to be between 15 and 45 degrees when the bait cage 100 is at rest (undeformed by user-applied forces). More particularly, certain implementations of the bait cage 100 may be manufactured with a ramp angle 178 from 30 to 45 degrees, from 35 to 40 degrees, or from 15 to 25 degrees. As illustrated in FIGS. 143 and 144, in implementations with a ramp angle 178, the rodent trap bait cage 100 may be configured such that, when the mounting portion 104 is engaged with the treadle plate 404, application of a downward force 126 on the roof section 164 toward the treadle plate 404 imparts torsion 138 on the bait pin detent portion 156 and thereby causes a temporary reduction in the ramp angle 178. The aforementioned wedging may cause a frictional engagement between the bait pin detent portion 156 and the bait pin 412.

Referring to FIGS. 8, 22, 38, 51, 65, 79, 104, and 150 in certain implementations of a rodent trap bait cage 100, the rodent trap bait cage has a first end 160 and a second end 162, and the barrier portion 102 includes a roof section 164 disposed oppositely of the mounting portion 104. In such implantations, the roof section 164 may be curved so as to be closer to the mounting portion 104 proximate the first end 160 than proximate the second end 162. Alternatively, as shown for example in FIG. 128, the roof section 164 may be curved so as to be the same distance from the mounting portion 104 proximate the first end 160 and the second end 162. Additionally or in the alternative, referring to FIGS. 8, 9, 22, 23, 38 and 39, the barrier portion 102 may include a pair of lateral walls 166 and a roof section 164 extending therebetween, and the roof section may be bowed upward from the lateral walls 166.

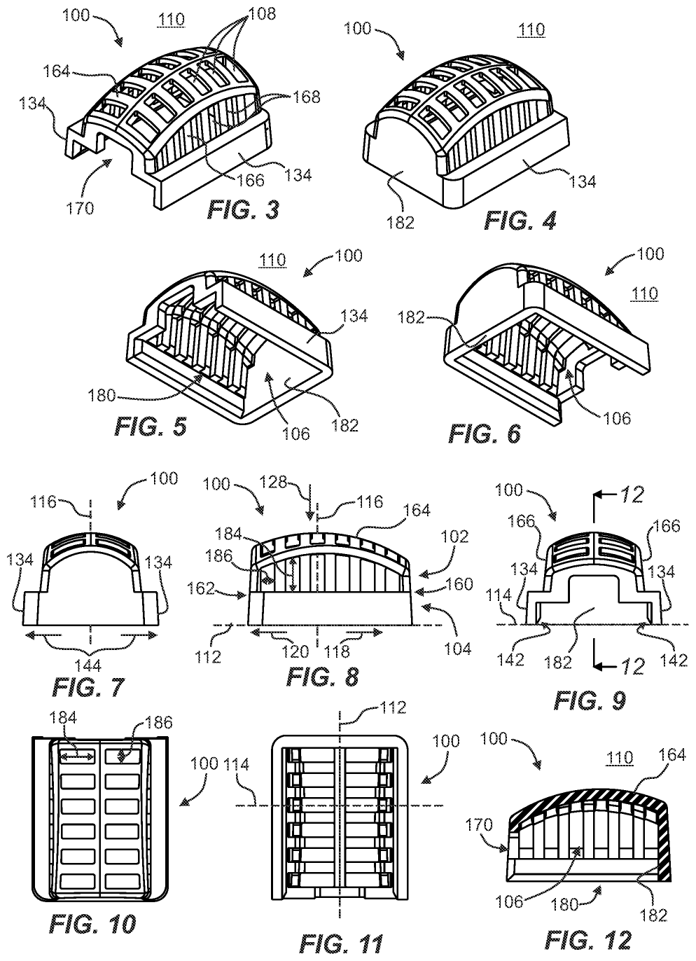

Referring to FIGS. 3, 17, 33 and 46, in particular implementations of a rodent trap bait cage 100, the barrier portion 102 may include a pair of lateral walls 166 and a roof section 164 extending therebetween, the lateral walls 166 may each have a lateral subset 168 of the bait access apertures, and in each lateral subset 168, the bait access apertures may be elongated in parallel with one another.

Referring to FIGS. 113-124, in particular implementations of a rodent trap bait cage 100 the barrier portion 102 may define a bait cavity 106 therein and including a multiplicity of bait access apertures 108 extending between the bait cavity 106 and an ambient environment 110 surrounding the barrier portion 102. Such an implementation may be configured to be mounted to rodent trap 400 by insertion of the mounting portion 104 into the bait holder 420 of the rodent trap 400.

Particular preferred implementations of a rodent trap bait cage 100 may be comprised of 80 Shore A nitrile rubber (NBR), or the like.

Referring to FIGS. 8 and 10, each bait access aperture (108, 168) may have an aperture length 184 and an aperture width 186. The bait access apertures may be elongated along their length 184. To help limit a rodent's ability to remove bait 176 from the bait cage 100, each of the bait access apertures may preferably have respective aperture widths 186 of 0.01 inch or less. In particular preferred implementations of a bait cage 100, the aperture width 186 may be between 0.065 and 0.095 inches.

Referring to FIGS. 14, 27, 29, 31, 43, 57, 71, 97, 110, 123 and 156, certain preferred implementations of a rodent trap system are shown generally at 200. A rodent trap system 200 may comprise a rodent trap 400 including a treadle plate 404, and an implementation of a rodent trap bait cage 100 as described or illustrated herein.

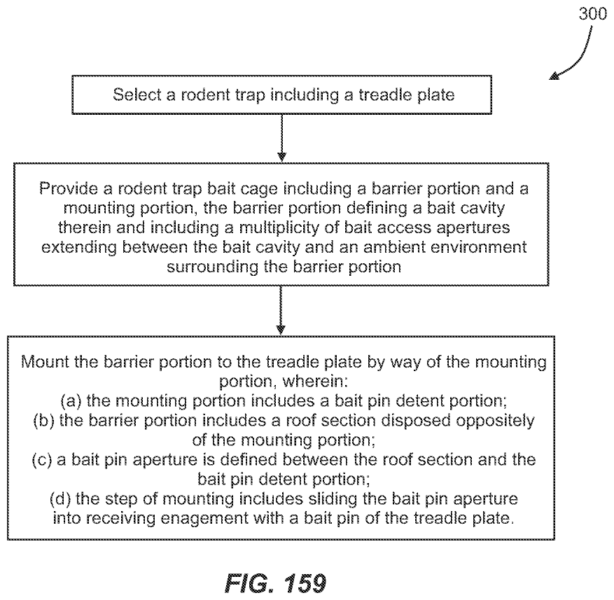

Referring to FIG. 159, a method 300 of deploying a rodent trap bait cage 100 on a rodent trap 400 may comprise selecting a rodent trap including a treadle plate, and providing a bait cage 100 including a barrier portion 102 and a mounting portion 104. The barrier portion 102 may define a bait cavity 106 therein and include a multiplicity of bait access apertures (108 and 168) extending between the bait cavity 106 and an ambient environment 110 surrounding the barrier portion 102. The method may include mounting the rodent trap bait cage 100 to the treadle plate 404 by way of the mounting portion 104.

Referring to FIGS. 109-111, in a method of deploying a rodent trap bait cage 100 on a rodent trap 400, the rodent trap bait cage 100 may include an adhesive layer 130 disposed on the mounting portion 104, and a peel layer 132 disposed on the adhesive layer 130 oppositely of the mounting portion 104. The step of mounting may include peeling the peel layer 132 from the adhesive layer 130, and pressing the bait cage 100 onto an upper face 410 of the treadle plate 404 so as to place the adhesive layer 130 in adhering communication between the mounting portion 104 and the treadle plate 404.

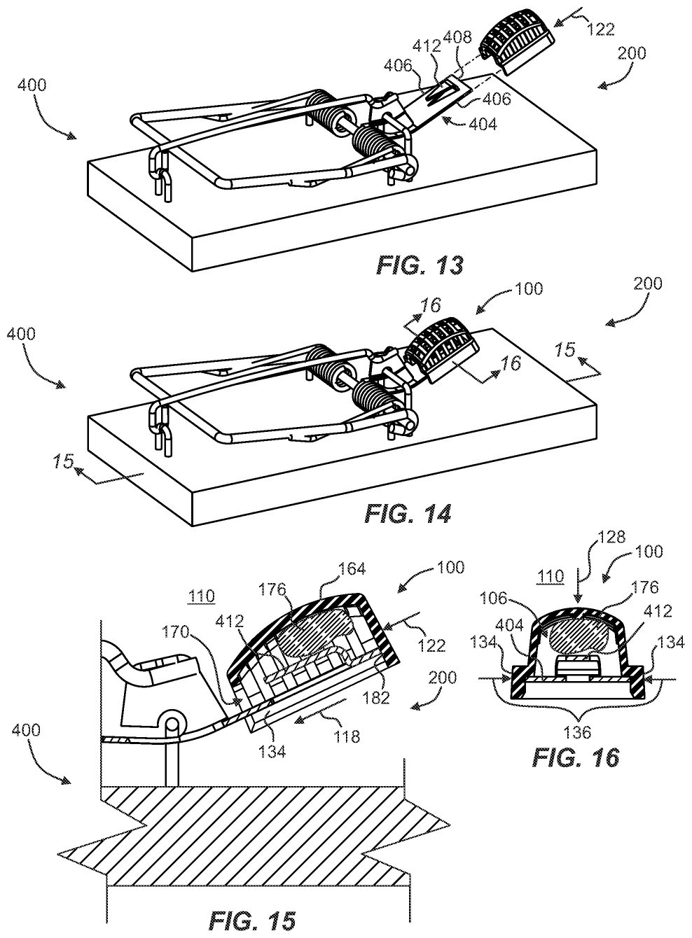

Referring to FIGS. 13-15, in certain implementations of a method of deploying a rodent trap bait cage 100 on a rodent trap 400, the mounting portion 104 may include a pair of laterally opposed plate engagement members 134. Moreover, the step of mounting may include placing the plate engagement members 134 into retaining engagement with a pair of lateral edges 406 of the treadle plate 404. In such a method, the retaining engagement may be by way of a lateral clamping force 136 exerted by the plate engagement members 134 on the treadle plate 404. As shown, for example, in FIGS. 13 and 14, the step of placing may be by way of applying a forward force 122 on the bait cage to cause the bait cage 100 to slidably receive the treadle plate 404. Referring to FIG. 15, the bait cage 100 may include a terminal detent portion 182 configured to engage a terminal edge 408 of the treadle plate 404 to limit how far the bait cage 100 may travel in a forward direction 118 over the treadle plate 404. Referring again to FIG. 15, the bait cage 100 may also include a bait pin relief 170 to allow the bait cage 100 to slidably receive the treadle plate 404 without the bait pin 412 interfering with movement of the bait cage 100 in a forward direction 118 along the treadle plate 404. The lateral clamping force 136 may be by way of elastic deformation of the rodent trap bait cage, as described above. Alternatively or in addition, the retaining engagement may be by way of static friction between the plate engagement members 134 and respective said lateral edges 406 of the treadle plate 404.

Referring to FIGS. 52 and 66, in certain implementations of a method of deploying a rodent trap bait cage 100 on a rodent trap 400, each of the plate engagement members 134 may include an edge slot 140. Referring to FIGS. 56-59 and 70-73 the retaining engagement may be by way of receipt of respective said lateral edges 406 of the treadle plate 404 into the edge slots 140. Again, referring to FIGS. 58 and 72, the bait cage 100 may include a terminal detent portion 182 configured to engage a terminal edge 408 of the treadle plate 404.to limit how far the bait cage 100 may travel in a forward direction 118 over the treadle plate 404.

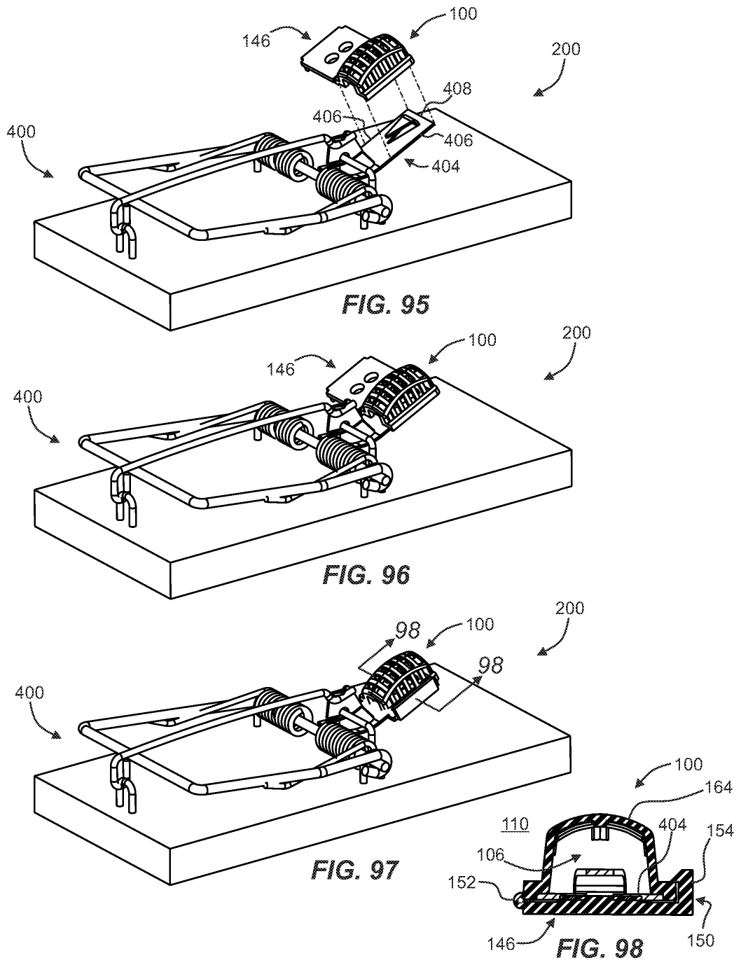

Referring to FIGS. 74-98, in certain implementations of a method of deploying a rodent trap bait cage 100 on a rodent trap 400, the mounting portion 104 may include a mounting door 146 and a pair of laterally-opposed plate engagement members 134. The mounting door 146 may have a hinge side 148 and a detent side 150 disposed oppositely of the hinge side 148. The hinge side 148 may be hingedly affixed to one of the plate engagement members 134 for hinged movement of the mounting door 146 between an open position and a closed position. The detent side 150 may be configured to releasably retain the mounting door 146 in the closed position. In this implementation of the deployment method, the step of mounting the bait cage 100 to the treadle plate 404 may include placing the plate engagement members 134 in contact with the treadle plate (e.g., by movement of the bait cage 100 in a downward direction 128 toward the treadle plate 404) with the mounting door 146 in the open position (see, e.g., FIGS. 95 and 96), and moving the mounting door 146 to the closed position with the treadle plate 404 releasably retained between the mounting door 146 and the barrier portion 102 (see, e.g., FIGS. 97 and 98). The detent side 150 may include a cantilever snap member 154 configured to snapingly engage the plate engagement member 134 opposite the plate engagement member 134 to which the hinge side 148 is hingedly affixed. In such case, in the deployment method, the cantilever snap member 154 causes the releasable retention of the mounting door 146 in the closed position.

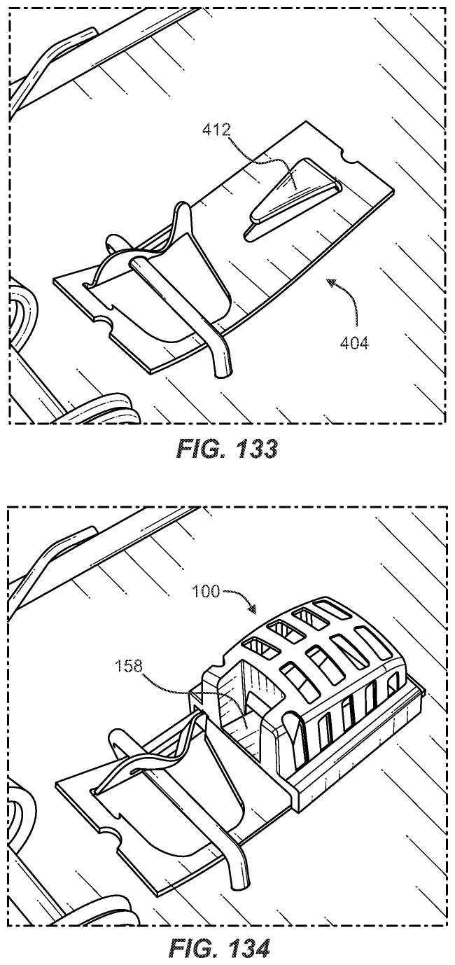

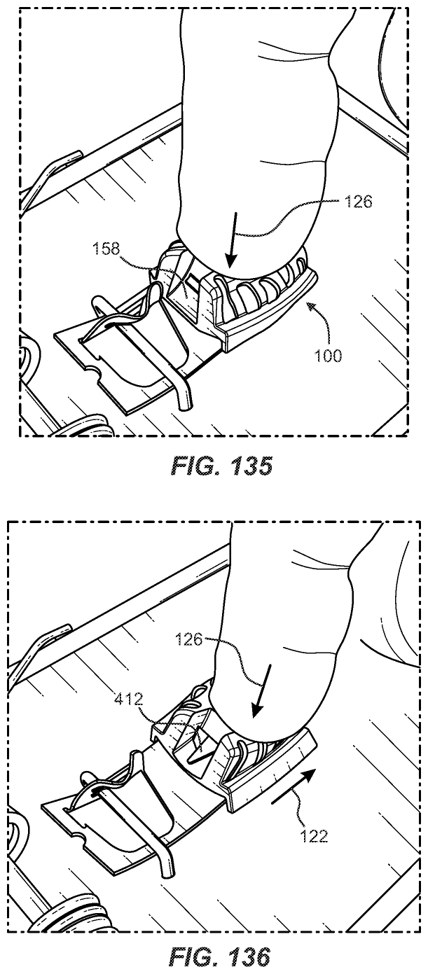

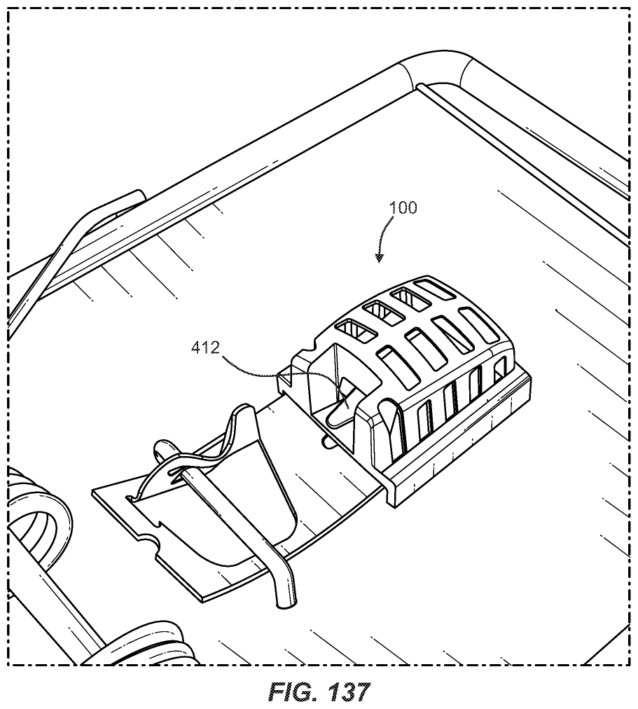

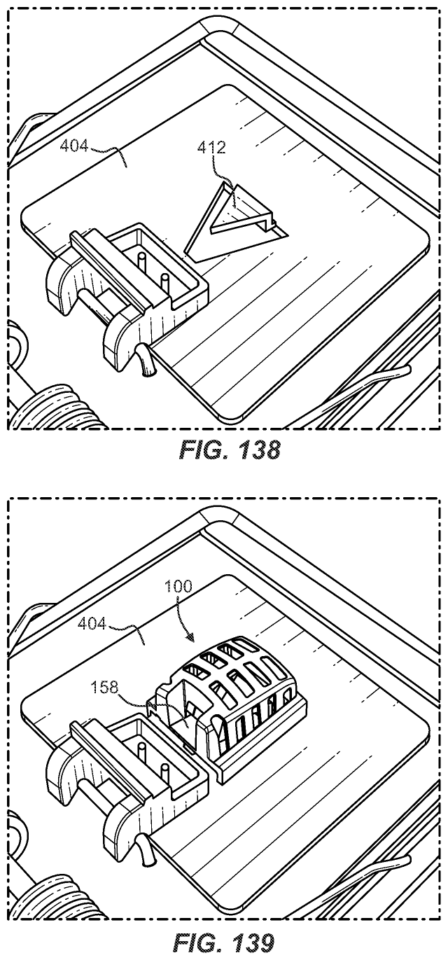

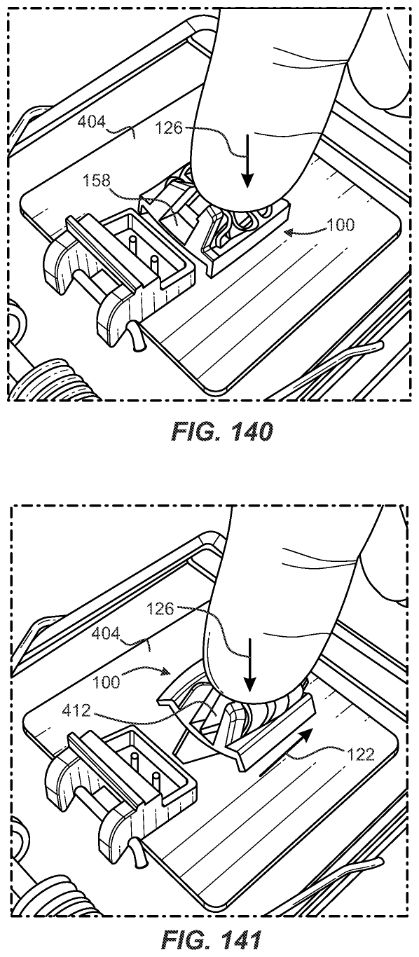

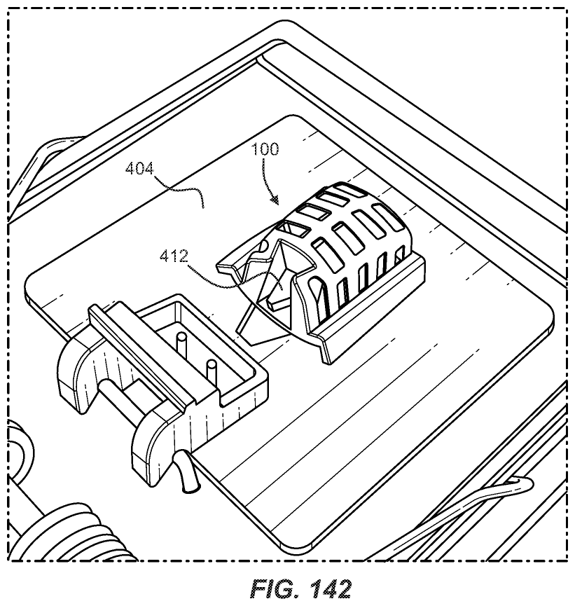

Referring to FIGS. 26-32, 42-45 and 133 to 144, in certain implementations of a method of deploying a rodent trap bait cage 100 on a rodent trap 400, the mounting portion 104 may include a bait pin detent portion 156, the barrier portion 102 may include a roof section 164 disposed oppositely of the mounting portion 104, and a bait pin aperture 174 may be defined between the roof section 164 and the bait pin detent portion 156. In such deployment methods, the step of mounting the bait cage 100 to the treadle plate 404 may include sliding the bait pin aperture 174 into receiving engagement with a bait pin 412 of the treadle plate 404. For the deployment method implementation illustrated in FIGS. 32, 45, and 143-144, the step of sliding may involve the user's application of a forward force 122 on the bait cage 100 to move the bait cage 100 in a forward direction 118 along the treadle plate 404. In contrast, for the deployment method implementation illustrated in FIGS. 28, 30, and 44, the step of sliding may involve the user's application of a rearward force 124 on the bait cage 100 to move the bait cage 100 in a rearward direction 120.

The bait pin detent portion 156 may have a ramped surface 158 to facilitate wedging of the bait pin detent portion 156 between the bait pin 412 and the treadle plate 404 during said sliding. Moreover, a ramp angle 178 may be defined between the ramped surface 158 and a longitudinal axis 112 of the rodent trap bait cage 100, and the step of mounting may include (i) prior to the step of sliding, placing the mounting portion 104 into engagement with the treadle plate 404 and applying a downward force 126 on the roof section 164 toward the treadle plate 404 so as to impart torsion 138 on the bait pin detent portion 156 and thereby cause a reduction in the ramp angle 178; (ii) during the step of sliding, maintaining the downward force 126; and (iii) after the step of sliding, releasing the downward force 126.

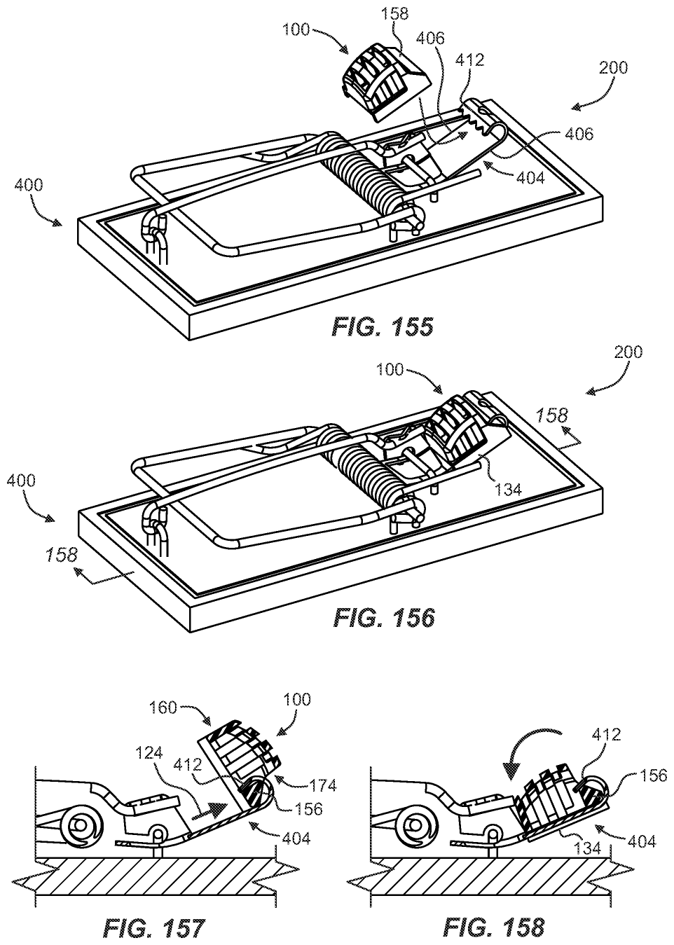

Referring to FIGS. 155-158, in certain examples of a rodent trap 400, the bait pin 412 may be configured as an arcuately-curved hook. Referring to FIG. 157, in such cases, the step of mounting the rodent trap bait cage 100 to the treadle plate 404 may include placing (e.g., snapping) the bait pin detent portion 156 under the bait pin 412 while the rodent trap bait cage 100 is in a partially upward precursor orientation. Referring to FIG. 158, the rodent trap bait cage 100 may then be rotated about the bait pin detent portion 156 to bring the plate engagement members 134 into retaining engagement with the lateral edges 406 of the treadle plate 404. The rodent trap bait cage 100 may be retained in this final mounted orientation by way of friction between the bait pin detent portion 156 and the bait pin 412, between the plate engagement members 134 and the lateral edges 406, or both.

The following listing matches certain terminology used within this disclosure with corresponding reference numbers used in the non-limiting embodiments illustrated in the several figures.
100 rodent trap bait cage
102 barrier portion
104 mounting portion
106 bait cavity
108 bait access apertures
110 ambient environment
112 longitudinal axis
114 lateral axis
116 vertical axis
118 forward direction
120 rearward direction
122 forward force (e.g., applied by user's finger in forward direction)
124 rearward force (e.g., applied by user's finger in rearward direction)
126 downward force (e.g., applied by user's finger in downward direction)
128 downward direction
130 adhesive layer
132 peel layer
134 plate engagement members (e.g., laterally opposed)
136 clamping force (e.g., laterally inward direction)
138 torsion (of bait pin detent portion)
140 edge slot (in plate engagement member)
142 lower inboard edge (e.g., tapered)
144 laterally outward direction
146 mounting door
148 hinge side (of mounting door)
150 detent side (of mounting door)
152 hinge (between mounting door and one plate engagement member)
154 cantilever snap member
156 bait pin detent portion
158 ramped surface (of bait pin detent portion)
160 first end (of rodent trap bait cage)
162 second end (of rodent trap bait cage)
164 roof section (of rodent trap bait cage)
166 lateral walls (of barrier portion)
168 lateral subset (of bait access apertures)
170 bait pin relief (extending through first end and mounting portion)
174 bait pin aperture (extending through second end)
176 bait
178 ramp angle (between longitudinal axis and ramped surface)
180 open bottom (of bait cage)
182 terminal detent portion
184 aperture length
186 aperture width
200 rodent trap system (comprising rodent trap and rodent trap bait cage)
300 method
400 rodent trap
402 base plate
404 treadle plate (of the rodent trap)
406 lateral edge (of treadle plate)
408 terminal edge (of treadle plate)
410 upper face (of treadle plate)
412 bait pin
414 movable jaw
416 helical spring
418 retaining lever
420 bait holder (e.g., attached to base plate)

There is no question that quick-kill rodent traps are exactly what they claim to be a device that delivers a quick kill to loitering rodents. The delicate trigger release mechanism and very strong and quick strike bar is generally effective at resulting in a death blow to rodents that contact the traps. It is known that rats and other rodents have very poor eyesight but extremely sensitive physical receptors, robust senses of smell, and a voracious appetites. It has been well-documented in the rodent bait world, especially for rats and mice, that peanut butter or hazelnut cocoa spread is an irresistible cuisine for rodents. Knowing this, but unsuccessfully containing this bait on a trap such that the triggering mechanism is released while the rodent is still busy with the bait, is one of the problems uniquely addressed by the present disclosure. The rodent trap bait cage, bait cage systems and methods disclosed herein require no tools to implement and augments the most popular quick-kill rodent traps available in the market today. Testing indicates that the solutions disclosed herein are highly successful in containing the most desired rodent bait, resulting in very high pest kill rates.

The rodent trap bait cages 100 disclosed herein are designed such that paste-type bait (e.g., peanut butter) can be pushed into cage through the perforations (bait access apertures) in outer structure after the cage has been installed onto the treadle plate or into holder. Using the cages, systems and methods disclosed herein ensures bait is nearest to surface of cage, and the perforations provide adequate surface area to retain the bait without having to fill the entire cage cavity. Moreover, the bait cages 100 are designed such that solid bait (e.g., bacon, cheese) can be placed inside the bait cage prior to installation of cage onto treadle plate or into the bait holder. The shape and size of the bait cage 100 is preferably gauged for the particular type of trap and type of rodent the trap is design to kill. The size of the bait cage is preferably adapted to ensure adequate bait volume to attract and entice rodents to access the bait. The bulbous shape and specifically sized and spaced perforations are such that bait scent is easily evacuated from cage. The bulbous shape and specifically sized and spaced perforations promote rodent access to the bait and encourage the rodent to vigorously attempt to access the bait. Perforations are preferably sized and spaced such that rodent teeth can intrude into the cage area to access the bait. The rodent will then be more likely to create motion to the cage and plate releasing the trigger mechanism while in position for the strike bar to make the swift kill. Furthermore, the rodent's teeth are likely to become entangled with the cage delaying its possible retreat. Certain preferred implementations of the bait cage 100 may be made of soft plastic, hard rubber, organic or mesh fabric material thus promoting confidence that the rodent can gnaw through the material and easily access the bait. The material of the bait cage is preferably tough enough to force the rodent to create significant motion to the cage and plate causing release of the trigger mechanism. Tooled pilot production parts were molded in 80 Shore A nitrile rubber (NBR), color black. The molding process may preferably require special mold release such that parts come out of mold odor-free and without oily film. The bait cage may be installed and removed from the trap bait plate or holder without fasteners or special tools. Preferred implementations of the bait cage are designed for cost-effective manufacturing and mass production. The cage encapsulates the bait such that past-type baits will remain preserved in their creamy, aromatic state longer should the trap remain set for several days prior to encounter with rodent.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A rodent trap bait cage comprising:
a barrier portion and a mounting portion, the barrier portion defining a bait cavity therein and including a multiplicity of bait access apertures extending between the bait cavity and an ambient environment surrounding the barrier portion, the rodent trap bait cage being configured to be mounted to a treadle plate of a rodent trap by way of the mounting portion;
wherein
(a) the mounting portion includes a bait pin detent portion;
(b) the barrier portion includes a roof section disposed oppositely of the mounting portion; and
(c) a bait pin aperture is defined between the roof section and the bait pin detent portion and is configured to slidingly receive a bait pin of the treadle plate to secure said mounting.

2. (canceled)

3. A rodent trap bait cage as defined in claim 1, wherein
the mounting portion includes a pair of laterally opposed plate engagement members, the plate engagement members each being configured to retainingly engage a respective lateral edge of the treadle plate; and
the mounting is by way of the retaining engagement and is releasable and repeatable.

4. A rodent trap bait cage as defined in claim 3, wherein the retaining engagement is by way of a lateral clamping force exerted by the plate engagement members on the treadle plate.

5. A rodent trap bait cage as defined in claim 4, wherein the lateral clamping force is by way of elastic deformation of the rodent trap bait cage.

6. A rodent trap bait cage as defined in claim 3, wherein the retaining engagement is by way of static friction between the plate engagement members and respective said lateral edges of the treadle plate.

7-8. (canceled)

9. A rodent trap bait cage as defined in claim 3, wherein each of the plate engagement members extends laterally outward of the barrier portion.

10-12. (canceled)

13. A rodent trap bait cage as defined in claim 1, wherein the bait pin detent portion has a ramped surface to facilitate wedging of the bait pin detent portion between the bait pin and the treadle plate during said sliding receipt.

14. A rodent trap bait cage as defined in claim 13, wherein
(a) a ramp angle is defined between the ramped surface and a longitudinal axis of the rodent trap bait cage; and
(b) the rodent trap bait cage is configured such that, when the mounting portion is engaged with the treadle plate, application of a downward force on the roof section toward the treadle plate imparts torsion on the bait pin detent portion and thereby causes a reduction in the ramp angle.

15. A rodent trap bait cage as defined in claim 13, wherein the wedging causes a frictional engagement between the bait pin detent portion and the bait pin.

16. A rodent trap bait cage as defined in claim 1, wherein
(a) the rodent trap bait cage has a first end and a second end; and
(b) the roof section is curved so as to be closer to the mounting portion proximate the first end than proximate the second end.

17. A rodent trap bait cage as defined in claim 1, wherein
(a) the barrier portion includes a pair of lateral walls, the roof section extending therebetween; and
(b) the roof section is bowed upward from the lateral walls.

18. A rodent trap bait cage as defined in claim 1, wherein
(a) the barrier portion includes a pair of lateral walls, the roof section extending therebetween;
(b) the lateral walls each have a lateral subset of the bait access apertures; and
(c) in each lateral subset, the bait access apertures are elongated in parallel with one another.

19. A rodent trap bait cage as defined in claim 1, wherein the rodent trap bait cage is comprised of 80 Shore A nitrile rubber (NBR).

20. A rodent trap system comprising:
a rodent trap including a treadle plate; and
a rodent trap bait cage including a barrier portion and a mounting portion, the barrier portion defining a bait cavity therein and including a multiplicity of bait access apertures extending between the bait cavity and an ambient environment surrounding the barrier portion, the barrier portion being configured to be mounted to the treadle plate by way of the mounting portion;
wherein
(a) the mounting portion includes a bait pin detent portion;
(b) the barrier portion includes a roof section disposed oppositely of the mounting portion; and
(c) a bait pin aperture is defined between the roof section and the bait pin detent portion and is configured to slidingly receive a bait pin of the treadle plate to secure said mounting.

21. (canceled)

22. A rodent trap system as defined in claim 20, wherein
(a) the mounting portion includes a pair of laterally opposed plate engagement members, each of the plate engagement members being in retaining engagement with a respective lateral edge of the treadle plate; and
(b) wherein the mounting is by way of the retaining engagement and is releasable and repeatable.

23. A rodent trap system as defined in claim 22, wherein the retaining engagement is by way of a lateral clamping force exerted by the plate engagement members on the treadle plate.

24. A rodent trap system as defined in claim 23, wherein the lateral clamping force is by way of elastic deformation of the rodent trap bait cage.

25. A rodent trap system as defined in claim 22, wherein the retaining engagement is by way of static friction between the plate engagement members and the respective said lateral edges of the treadle plate.

26-27. (canceled)

28. A rodent trap system as defined in claim 22, wherein each of the plate engagement members extends laterally outward of the barrier portion.

29-31. (canceled)

32. A rodent trap system as defined in claim 20, wherein the bait pin detent portion has a ramped surface to facilitate wedging of the bait pin detent portion between the bait pin and the treadle plate during said sliding receipt.

33. A rodent trap system as defined in claim 32, wherein
(a) a ramp angle is defined between the ramped surface and a longitudinal axis of the rodent trap bait cage; and
(b) the rodent trap bait cage is configured such that, when the mounting portion is engaged with the treadle plate, application of a downward force on the roof section toward the treadle plate imparts torsion on the bait pin detent portion and thereby causes a reduction in the ramp angle.

34. A rodent trap system as defined in claim 32, wherein the wedging causes a frictional engagement between the bait pin detent portion and the bait pin.

35. A rodent trap system as defined in claim 20, wherein
(a) the rodent trap bait cage has a first end and a second end; and
(b) the roof section is curved so as to be closer to the mounting portion proximate the first end than proximate the second end.

36. A rodent trap system as defined in claim 20, wherein
(a) the barrier portion includes a pair of lateral walls, the roof section extending therebetween; and
(b) the roof section is bowed upward from the lateral walls.

37. A rodent trap system as defined in claim 20, wherein
(a) the barrier portion includes a pair of lateral walls, the roof section extending therebetween;
(b) the lateral walls each have a lateral subset of the bait access apertures; and
(c) in each lateral subset, the bait access apertures are elongated in parallel with one another.

38. A rodent trap system as defined in claim 20, wherein the rodent trap bait cage is comprised of 80 Shore A nitrile rubber (NBR).

39. A method of deploying a rodent trap bait cage on a rodent trap, the method comprising:
selecting a rodent trap including a treadle plate; and
providing a rodent trap bait cage including a barrier portion and a mounting portion, the barrier portion defining a bait cavity therein and including a multiplicity of bait access apertures extending between the bait cavity and an ambient environment surrounding the barrier portion;
mounting the barrier portion to the treadle plate by way of the mounting portion;
wherein
(a) the mounting portion includes a bait pin detent portion;
(b) the barrier portion includes a roof section disposed oppositely of the mounting portion;
(c) a bait pin aperture is defined between the roof section and the bait pin detent portion; and
(d) the step of mounting includes sliding the bait pin aperture into receiving engagement with a bait pin of the treadle plate.

40. (canceled)

41. A method as defined in claim 39, wherein
(a) the mounting portion includes a pair of laterally opposed plate engagement members; and
(b) the step of mounting includes placing the plate engagement members into retaining engagement with a pair of lateral edges of the treadle plate.

42. A method as defined in claim 41, wherein the retaining engagement is by way of a lateral clamping force exerted by the plate engagement members on the treadle plate.

43. A method as defined in claim 42, wherein the lateral clamping force is by way of elastic deformation of the rodent trap bait cage.

44. A method as defined in claim 41, wherein the retaining engagement is by way of static friction between the plate engagement members and respective said lateral edges of the treadle plate.

45. (canceled)

46. A method as defined in claim 41, wherein each of the plate engagement members extends laterally outward of the barrier portion.

47-49. (canceled)

50. A method as defined in claim 39, wherein the bait pin detent portion has a ramped surface to facilitate wedging of the bait pin detent portion between the bait pin and the treadle plate during said sliding.

51. A method as defined in claim 50, wherein
(a) a ramp angle is defined between the ramped surface and a longitudinal axis of the rodent trap bait cage; and
(b) the step of mounting includes
(i) prior to the step of sliding, placing the mounting portion into engagement with the treadle plate and applying a downward force on the roof section toward the treadle plate so as to impart torsion on the bait pin detent portion and thereby cause a reduction in the ramp angle;
(ii) during the step of sliding, maintaining the downward force; and
(iii) after the step of sliding, releasing the downward force.

52. A method as defined in claim 50, wherein the wedging causes a frictional engagement between the bait pin detent portion and the bait pin.

53. A method as defined in claim 39, wherein the rodent trap bait cage is comprised of 80 Shore A nitrile rubber (NBR).

54. (canceled)

55. A rodent trap bait cage as defined in claim 1, wherein the bait pin is configured as an arcuately-curved hook.

56. A rodent trap system as defined in claim 20, wherein the bait pin is configured as an arcuately-curved hook.

57. A method as defined in claim 41, wherein
(a) the bait pin is configured as an arcuately-curved hook; and
(b) the step of mounting includes
(i) placing the bait pin detent portion under the bait pin, and
(ii) rotating the rodent trap bait cage about the bait pin detent portion to bring the plate engagement members into said retaining engagement with the lateral edges.
